(19) United States
(12) Patent Application Publication
(10) Pub. No.: US 2024/0399432 A1
(43) Pub. Date: Dec. 5, 2024

(54) SYSTEMS AND METHODS FOR UTILIZING FOAM FRACTIONATION FOR CONTAMINATE DESTRUCTION

(71) Applicant: Battelle Memorial Institute, Columbus, OH (US)

(72) Inventors: Slawomir WINECKI, Dublin, OH (US); Devin DICKSON, Columbus, OH (US); Chris HALL, Fort Myers, FL (US); Stephanie NAPIERALSKI, Columbus, OH (US); Philip KESTER, Midland, OH (US); Emma BRACKMAN, Columbus, OH (US); Leonardo CHIQUES, CAPE CORAL, FL (US); Hong Be TRUONG, Lewis Center, OH (US)

(73) Assignee: BATELLE MEMORIAL INSTITUTE, Columbus, OH (US)

(21) Appl. No.: 18/680,812

(22) Filed: May 31, 2024

Related U.S. Application Data
(63) Continuation-in-part of application No. 18/642,499, filed on Apr. 22, 2024.
(60) Provisional application No. 63/587,092, filed on Sep. 30, 2023.
(60) Provisional application No. 63/587,102, filed on Sep. 30, 2023.
(60) Provisional application No. 63/470,631, filed on Jun. 2, 2023.
(60) Provisional application No. 63/587,097, filed on Sep. 30, 2023.
(60) Provisional application No. 63/587,095, filed on Sep. 30, 2023.

(51) Int. Cl. B09B 3/40; B09B 3/35; B09B 101/75; B09C 1/06

(52) U.S. Cl. CPC B09B 3/40; B09B 3/35; B09C 1/065; B09B 2101/75

(57) ABSTRACT

A system for the destruction of PFAS compounds through mineralization with reactive oxides is disclosed herein. The system includes an acquisition unit for obtaining reactive oxides. The system also includes a mixing unit operatively connected to the acquisition unit, where the mixing unit is configured to combine PFAS-contaminated waste with the reactive oxides. The system also includes a high-temperature treatment unit operatively connected to the mixing unit to subject the mixture of PFAS-contaminated waste and reactive oxides to a chemical reaction. The system includes a cooling unit operatively connected to the high-temperature treatment unit. The system includes a waste collection receptacle connected to the cooling unit. The system includes particulate vapor treatment systems, where PFAS-contaminated atmospheres from the high-temperature treatment unit and the cooling unit are captured to prevent emissions to the environment.

### CROSS-REFERENCE TO RELATED PATENT APPLICATIONS

This application claims priority to U.S. Appl. Ser. No. 63/587,092, filed Sep. 30, 2023, entitled “Systems and Methods for AFFF Destruction,” which patent application is commonly owned by the owner of the present invention. This application claims priority to U.S. Appl. Ser. No. 63/587,102, filed Sep. 30, 2023, entitled “Methods And Systems For PFAS Destruction And Mineralization,” which patent application is commonly owned by the owner of the present invention. This application is a continuation-in-part application and claims priority to U.S. patent application Ser. No. 18/642,499, filed Apr. 22, 2024, entitled “Systems and Methods for Utilizing Foam Fractionation to Separate and Eliminate PFAS,” which claims priority to U.S. Patent Appl. Ser. No. 63/470,631, filed Jun. 2, 2023, entitled “Systems and Methods for Utilizing Foam Fractionation to Separate and Eliminate PFAS,” and U.S. Patent Appl. Ser. No. 63/587,097, filed Sep. 30, 2023, entitled “Systems and Methods for Flexible Foam Fractionation,” and U.S. Patent Appl. Ser. No. 63/587,095, filed Sep. 30, 2023, entitled “Systems and Methods for Foam Draining Using Angled Foam Fractionation Columns,” which patent applications are commonly owned by the owner of the present invention. These patent applications are incorporated herein in their entirety.

### TECHNICAL FIELD

The present disclosure relates to an improved treatment systems and methods for removing, isolating, or separating a substance from water or aqueous solutions. In particular, the present disclosure relates to the separation of perfluoroalkyl or polyfluoroalkyl substances from water. Embodiments of the present disclosure can also be applied can also be applied to the removal of non-organic materials or contaminants from all types of contaminated water sources. In particular, the present disclosure relates to the separation and removal of perfluoroalkyl or polyfluoroalkyl substances, volatile organic compounds, non-organic materials, or other contaminants from all types of contaminated water sources.

The systems, methods, and related apparatuses of the present disclosure relate to the removal of contaminants through the use of foam fractionation processes with gas recycling capabilities.

Moreover, the system, method, and related apparatuses of the present disclosure relates to the removal of contaminants from a contaminated water source through the use of foam fractionation processes. More particularly, aspects and embodiments of the present disclosure disclosed herein are related to a sustainable and efficient removal and elimination of perfluoroalkyl and polyfluoroalkyl substances (PFAS) from water using continuous, multistage foam fractionation processes.

In some embodiments, aspects and embodiments of the present disclosure disclosed herein are related to a sustainable and efficient removal and elimination of perfluoroalkyl and polyfluoroalkyl substances (PFAS) from water using foam fractionation processes with flexibility to meet required flexibility to meet output requirements in terms of concentration, flow, and combinations thereof.

Moreover, the system, method, and related apparatuses of the present disclosure relates to the removal of contaminants from a contaminated source through the use of foam fractionation processes. More particularly, aspects and embodiments of the present disclosure disclosed herein are related to a sustainable and efficient removal and elimination of perfluoroalkyl and polyfluoroalkyl substances (PFAS) from water using continuous, multistage foam fractionation processes.

Further, the present disclosure relates to the removal of total organic carbon from PFAS-contaminated sources during the process of destroying the PFAS in the contaminated source.

In particular, the present disclosure relates to the separation of perfluoroalkyl or polyfluoroalkyl substances from water, as well as non-organic materials and contaminants found in various water sources affected by industrial, municipal, or natural processes. Embodiments of the present disclosure can also be applied can also be applied to the removal of non-organic materials or contaminants from all types of contaminated water sources.

Moreover, the system, method, and related apparatuses of the present disclosure relate to the removal of contaminants from a contaminated water source through the use of foam fractionation processes. More particularly, aspects and embodiments of the present disclosure disclosed herein are related to a sustainable and efficient removal and elimination of perfluoroalkyl and polyfluoroalkyl substances (PFAS) from water using continuous, multistage foam fractionation processes. Within the context of environmental remediation, this disclosure emphasizes the use of continuous, multistage foam fractionation processes to produce a PFAS-rich foam and chemically reactive agents such as calcium oxide (CaO) or magnesium oxide (MgO) with enhanced reactivity to produce a pollutant free stream.

Furthermore, the present disclosure relates to destruction of contaminates with reactive oxides. In particular, the present disclosure includes systems and methods for the destruction of contaminated sources, such as containers, streams, and soils, by using the processes for destruction of PFAS compounds via mineralization with reactive oxides.

### STATEMENT OF FEDERALLY FUNDED RESEARCH

None.

### BACKGROUND

Perfluoroalkyl and polyfluoroalkyl materials (PFAS) are a class of compounds that have been used in the manufacture of consumer and industrial chemicals. The PFAS chemical class comprises thousands of human-made chemicals. In fact, current estimates by the Organization for Economic Cooperation and Development (“OECD”) predict that there are over 4,700 distinct PFAS chemicals. The most commonly utilized PFAS are perfluorooctanoic acid (“PFOA”) and perfluorooctane sulfonic acid (“PFOS”).

The feature that makes all of these chemicals fall within the class of PFAS is a particular kind of bond present within the chemical. Specifically, each of these chemicals has at least one atom of carbon bound to a fluorine atom (a C—F bond). This short polar-covalent chemical bond makes these substances extremely strong. Most PFAS—including the once commonly utilized chemicals of PFOA and PFOS—break down exceptionally slowly and remain in the environment, leading to PFAS being noted as “forever chemicals.”

For a longstanding period of time, the public was unaware of the toxicity of PFAS. In stark contrast to the environmental hazard that PFAS are currently viewed as posing, PFAS were considered a useful addition to the commercial industry when first introduced in the 1940s. PFAS were durable, resistant to extreme temperatures, hydrophobic, and oleophobic. Because of these qualities, PFAS were quickly incorporated into a variety of products: microwavable food packaging, stain-resistant carpet coating, Teflon cookware, and firefighting foam.

Mass amounts of these products were manufactured and subsequently stored or disposed of worldwide. In particular, aqueous film-forming foams (AFFF) has been used extensively as a fire suppressant. In fact, AFFF was a longstanding primary fire suppressant utilized by global military fire training bases. AFFF works by covering a fuel spill, cooling surfaces, and preventing re-ignition. After product use, PFAS would disperse into the ecosystem. In particular, the AFFF, when used for training firefighters, military use, and at-home fire protection, were intentionally routed to run-off to the nearest water system. These practices resulted in PFAS deposits into soil, rivers, lakes, well water and drinking water.

The widespread, long-term use of PFAS compounds in products such as firefighting foams has led to extensive contamination of soil and groundwater. But, there are also situations in which a small area of soil may quickly become highly contaminated, such as for instance, if a few buckets of AFFF were spilled. In these situations, there is a need for a system that can quickly and efficiently destroy PFAS directly in a small quantity of highly contaminated soil.

PFAS has been proven toxic when introduced into the human body. PFAS introduced into the body through ingestion of drinking contaminated water will not decompose and instead will bioaccumulate. The bioaccumulation results in PFAS entering the bloodstream, which can result in long-term, adverse health effects in humans, such as cancer, and developmental health effects, such as low birth weight.

Moreover, beyond human effects, PFAS can contaminate animal bloodstreams as well. PFAS has been found in mammals' milk and animal offspring, leading to dairy farm shutdowns. The consumption of contaminated milk, from either humans or other mammals exposed to PFAS, by babies and young children was also shown to lead to negative developmental health effects.

In 2016, the U.S. Environmental Protection Agency (EPA) issued the following Health Alerts (HA) for PFOA and PFOS: the sum of the individual components and concentrations for PFOS and PFOA, respectively, is 0.07 .mu.g/L. In response to the increasing harms being linked to PFAS, the United States Agency for Toxic Substances and Disease Registry conducted a study on the health effects of PFAS and developed estimate minimal risk levels for common PFAS. The study revealed that even low concentrations of PFAS may be associated with adverse health outcomes. In particular, the study noted that drinking water containing concentrations for PFOA of 78 parts per trillion (ppt) for adults and 21 ppt for children, and for PFOS of 52 ppt for adults and 14 ppt for children, would lead to health problems.

While the harms associated with PFAS are now recognized, addressing and correcting the problems associated with PFAS remains a difficulty—especially when attempting to handle the decontamination of PFAS-contaminated sources in large quantities. Because of PFAS's extreme stability, based on the above-mentioned carbon-fluorine bonds, the PFAS contaminants are highly resistant to degradation. Accordingly, to decontaminate exposed water and aqueous solutions, processes must involve targeted removal of PFAS.

Most of the available conventional water treatment systems and methods of removing PFAS from water have proven ineffective. Specifically, conventional systems and methods that attempt to remove PFAS also include biological treatment, air stripping, reverse osmosis and advanced oxidation. All of these conventional techniques are inefficient and often are extremely expensive in practice.

Foam fractionation is a chemical process in which hydrophobic molecules are preferentially separated from a liquid solution using rising columns of air bubbles, with a resulting foam layer on top of the solution trapping the hydrophobic molecule. In general two mechanisms provide for effective removal of molecules from a solution, first a target molecule adsorbs to a bubble surface, and then the bubbles travel up a column and form a foam layer on top which can be collected and disposed of.

Further, streams containing volatile organic compounds can also contaminate aqueous sources after such compounds are produced by industrial processes. The contamination from volatile organic compounds may arise from the transfer of liquids from one containment body to another due to the displacement of air or liquid, by their volatilization during the industrial process, or by contaminated soil remediation or other environmental cleanup operations. Air used in processes for the removal of volatile organic compounds may become saturated with vapors containing volatile organic compounds that can cause environmental damage or health issues if released into the atmosphere.

Foam fractionation predominantly removes surfactant contaminant molecules (molecules that have polar and non-polar ends). At the air-water interface of the bubbles the surfactant molecules orientate themselves so that the non-polar hydrophobic end of the surfactant molecules is in air and the polar hydrophilic end of the molecule is in water. As the bubbles rise to the top of the fractionating column they remove the contaminants and settle at the top of the column as a foam.

Many organic substances can be removed by foam fractionation and larger biological material, such as algae, bacteria and viruses can also be removed. Particles present in the water can also be removed. Inorganic material can also be removed based on the formation of a bond between the inorganic material with the organic matter or a surfactant in the water. For example, calcium carbonate and calcium phosphate complexes can collect organic matter in the water forming micro-flocs that can get trapped in the film surrounding the air bubbles. Metal ions can also form ligands with organic molecules, and glycoproteins have a high affinity for trace metals and therefore facilitate removal of metal ion species from water.

Efficient contaminant removal is complex and depends on many factors including air to water ratio; column height; air bubble diameter; air/water contact time; air bubble flow rate; foaming agent; foam wetness; downward water flow rate; foam stability; and collision speed between the water and the rising gas. Foam stability is also an important factor and can be defined as the resistance to water and contaminant drainage from the foam, without foam rupturing. The foam must be stable enough to be removed from the fractionating column, without leaching of the contaminant molecules into the water.

Efforts to use foam fractionation for the removal of PFAS contaminants often relies on batch processes, which can prove difficult to both scale and to operate. When attempting to scale batch processes for using foam fractionation to remove PFAS from water and aqueous solutions, operators are necessary to control feedback and intervention in the process. Moreover, those using foam fractionation systems are in need of a flexible system that can meet their output requirements in terms of concentration, flow, or a combination thereof. Moreover, those using foam fractionation systems are in need of a flexible system that can meet their output requirements in terms of concentration, flow, or a combination thereof.

Additionally, foam fractionation often requires large volumes of foam-forming gas. Foam fractionation processes typically use compressed air in a pass-through mode, in which air is used only once to form a foam and then the air is vented to atmosphere.

The single use of air poses significant problems because the vented air may be contaminated with volatile water pollutants. For instance, the single use may contain short carbon chain PFAS compounds, other volatile organic compounds, or combinations thereof. Prevention of the release of contaminant compounds into the atmosphere requires the costly addition of an air purification method.

Moreover, the single use of air in a foam fractionation system poses significant problems because of the processing of volatile or flammable liquid streams, for instance water mixed with solvents, using air can be dangerous. While the use of inert gases would lead to a safer system, these gases are prohibitively expensive to use only once and then vent in a process to produce foam.

Accordingly, there is a need to develop a PFAS removal system and method that can extract, separate, or isolate PFAS from water or aqueous solutions in a manner that is effective, low-cost, scalable, and safe to operate. There is also a need to develop a mobile system that can be controlled in terms of flow capacity and concentration capability. Specifically, there is a need to develop a PFAS removal system and method that can extract, separate, or isolate PFAS from water or aqueous solutions in a manner that is effective, low-cost, scalable, and safe to operate. There is also a need to develop a mobile system that can be controlled in terms of flow capacity and concentration capability.

Moreover, PFAS and PFOA destruction also may pose challenges related to concentration, functional groups, and co-contaminants in the materials requiring treatment. Prior practices have often led to the generation of vapors, corrosion, and undesirable outcomes. There is a need for a system that can eradicate PFAS material without impacting the equipment or the environment, operating at ambient pressure and relatively low temperature, addressing these challenges without the need for exotic materials of construction or high energy demand.

In fact, prior practices for PFAS destruction face significant hurdles to widespread adoption and are not suitable for all types of PFAS-contaminated waste. For example, supercritical water oxidation (SCWO) suffers from corrosion and plugging issues if the influent contains certain problematic contaminants or solids. Combatting this problem requires filtering, costly consumables, and analytical testing, as well as preventive maintenance downtime and careful batch testing. Electrochemical methods can consume large amounts of energy and have the potential to form toxic byproducts. Moreover, in many situations, such as with the plastic buckets that are used to store aqueous film-forming foam (AFFF), it is not feasible to clean containers sufficiently such that they can be re-used or discarded in a regular landfill. Therefore, a versatile, scalable, cost-effective system that destroys PFAS without producing toxic byproducts is needed.

In fact, prior practices for PFAS destruction face significant hurdles to widespread adoption and are not suitable for all types of PFAS-contaminated waste. For example, supercritical water oxidation (SCWO) suffers from corrosion and plugging issues if the influent contains certain problematic contaminants or solids. Combatting this problem requires filtering, costly consumables, and analytical testing, as well as preventive maintenance downtime and careful batch testing. Electrochemical methods can consume large amounts of energy and have the potential to form toxic byproducts. Moreover, in many situations, such as with the plastic buckets that are used to store aqueous film-forming foam (AFFF), it is not feasible to clean containers sufficiently such that they can be re-used or discarded in a regular landfill. Therefore, a versatile, scalable, cost-effective system that destroys PFAS without producing toxic byproducts is needed.

Accordingly, there is a need to develop a PFAS removal system and method that effectively, affordably, and safely extracts, separates, or isolates PFAS from water or aqueous solutions, while also addressing the destruction of PFAS in containers such as plastic buckets used for storing AFFF. As such, there is a need for a system capable of handling both large-scale and small-scale contaminations, ensuring minimal environmental and equipment impact.

Accordingly, there is a need to develop a PFAS removal system and method that can extract, separate, or isolate PFAS from water or aqueous solutions in a manner that is effective, low-cost, scalable, and safe to operate.

Moreover, there exists a need for a system and method for PFAS and PFOA removal from gas and vapor streams that overcomes challenges related to concentration, functional groups, co-contaminants, and undesirable byproducts. Such a system should operate at ambient pressure and relatively low temperature, ensuring minimal equipment and environmental impact. Additionally, it should offer cost-effective and safe removal methods, producing an effluent stream that is essentially inert.

Moreover, the need extends to a system and method for PFAS and PFOA removal from gas and vapor streams, particularly in high-temperature waste treatment systems. When operating at high temperatures, a portion of the PFAS to be treated will end up in the atmosphere of the waste treatment system. Thus, there is a critical requirement for a method to destroy PFAS in the flue gas of high-temperature waste treatment systems to prevent environmental emission. Such a system should operate efficiently at ambient pressure and relatively low temperature, ensuring minimal equipment and environmental impact while offering a cost-effective and safe removal method, producing an effluent stream that is essentially inert.

### SUMMARY OF THE INVENTION

The present disclosure relates to system and methods for using foam fractionation to remove a PFAS contaminant from a water source. In accordance with one or more embodiments, the systems and methods disclosed herein relate to the separation, concentration, and destruction of PFAS from a source of water that is contaminated with PFAS.

The present invention is, in certain embodiments, directed to a method and system for using a continuous foam fractionation process to remove PFAS from AFFF. From this, in some embodiments, the method and system may be utilized to remove PFAS compounds from highly contaminated streams. In some embodiments, prior to the removal and destruction of the PFAS compounds from the highly contaminated source, the method and system may include the removal of total carbon content from the highly contaminated source, such as AFFF.

In general, in one embodiment, the disclosure features a system for the destruction of PFAS compounds through mineralization with reactive oxides. The system includes an acquisition unit for obtaining reactive oxides; a mixing unit operatively connected to the acquisition unit, where the mixing unit is configured to combine PFAS-contaminated waste with the reactive oxides. The system also includes a high-temperature treatment unit operatively connected to the mixing unit, where the high-temperature treatment unit is configured to subject the mixture of PFAS-contaminated waste and reactive oxides to a chemical reaction. The system also includes a cooling unit operatively connected to the high-temperature treatment unit, where the cooling unit is configured to cool the mixture post high-temperature treatment to create a cooled mixture. The system also includes a waste collection receptacle connected to the cooling unit, where the cooled mixture is directed for disposal. The system also includes one or more particulate vapor treatment systems connected to the high-temperature treatment unit and the cooling unit, where PFAS-contaminated atmospheres from the high-temperature treatment unit and the cooling unit are captured to prevent emissions to the environment.

In general, in another embodiment, the invention features a method for treating highly contaminated soil using a PFAS mineralization system. The method includes obtaining a quantity of highly contaminated soil, where the highly contaminated soil comprises PFAS compounds. The method also includes mixing the obtained soil with reactants selected from the group consisting of oxides, hydroxides, or a combination thereof. The method also includes placing the mixture into a high-temperature treatment unit to allow for chemical decomposition of the PFAS compounds, where the placing the mixture into a high-temperature treatment unit results in a treated mixture. The method also includes cooling the treated mixture to create a cooled mixture. The method also includes disposing of the cooled mixture.

In general, in one embodiment, the disclosure features a method for the destruction of AFFF and other wastes containing PFAS compounds. The method includes introducing a contaminated source, where the contaminated source includes PFAS contaminants, non-PFAS contaminates, and an aqueous solution. The method also includes oxidizing the non-PFAS contaminates in the introduced contaminated stream, thereby leaving most of the PFAS contaminants in their original form and decomposing non-PFAS contaminants present in the contaminated stream. The method also includes utilizing foam fractionation-based separation and concentration of PFAS compounds. The method also includes, resultant from utilizing foam fractionation-based separation, producing a first stream comprising concentrated PFAS compounds and a second stream comprising purified water. The method also includes destroying the concentrated PFAS compounds in the first stream.

In general, in another embodiment, the disclosure features a method for removing total organic carbon (TOC) prior to supercritical water oxidation of a contaminated stream, the method including introducing a contaminated stream including PFAS contaminants and non-PFAS contaminants, where the non-PFAS contaminants include TOC. The method also includes diluting the introduced stream to a level suitable for measuring the TOC. The method also includes applying an applied amount of UV radiation to reduce a content of the TOC; oxidizing the non-PFAS contaminants, leaving most of the PFAS compounds in the contaminated stream.

### BRIEF DESCRIPTION OF THE DRAWINGS

Other advantages of the present invention will be apparent from the following detailed description of the invention in conjunction with embodiments as illustrated in the accompanying drawings, in which:

FIG. 1 depicts a continuous foam fractionation system for use with water contaminated with PFAS, in accordance with certain embodiments of the present disclosure.

FIG. 2 depicts a process for removing and disposing of concentrated PFAS using a continuous foam fractionation system for use with water contaminated with PFAS, in accordance with certain embodiments of the present disclosure.

FIG. 3 depicts a supercritical water oxidation method for use in a process for removing and disposing of concentrated PFAS using a continuous foam fractionation system for use with water contaminated with PFAS, in accordance with certain embodiments of the present disclosure.

FIG. 4 depicts a block diagram of a method for using a continuous foam fractionation system to treat water contaminated with PFAS, in accordance with certain embodiments of the present disclosure.

FIG. 5 depicts a diagram of a modular system that allows for flexibility in flow and concentration based on capabilities and needs of a system, in accordance with certain embodiments of the present disclosure.

FIG. 6 depicts a diagram of a system that allows for flow routing using a plurality of inlet ports, in accordance with certain embodiments of the present disclosure.

FIG. 7 depicts a diagram demonstrating the ability to increase concentration in system that allows for the modular components in a system flexible foam fractionation to be removed from a housing, in accordance with certain embodiments of the present disclosure.

FIG. 8 depicts a foam fractionation system with ports for adding additional surfactant, in accordance with certain embodiments of the present disclosure.

FIG. 9 depicts an angled foam fractionation column, in accordance with certain embodiments of the present disclosure.

FIG. 10 depicts a process diagram for the destruction of AFFF, in accordance with certain embodiments of the present disclosure.

FIG. 11 depicts a schematic continuous process for treating PFAS/PFOA contaminated foam streams with reactive metal oxides, in accordance with embodiments of the present disclosure.

FIG. 12 depicts a schematic of the first step of a two-step batch process for treating PFAS/PFOA contaminated foam streams with reactive metal oxides, showing the capture of PFAS/PFOA contaminated foam in accordance with embodiments of the present disclosure.

FIG. 13 depicts a schematic of the second step of a two-step batch process for treating PFAS/PFOA contaminated foam streams with reactive metal oxides, showing the actual destruction of the PFAS/PFOA compounds in accordance with embodiments of the present disclosure.

FIG. 14 depicts an apparatus PFAS/PFOA mineralization, in accordance with certain embodiments of the present disclosure.

FIG. 15 depicts a block diagram of a system for the destruction of PFAS compounds via mineralization with reactive oxides, in accordance with certain embodiments of the present disclosure.

FIG. 16 depicts an illustration of an exemplary embodiment of a system for the destruction of PFAS compounds via mineralization with reactive oxides, in accordance with certain embodiments of the present disclosure.

FIG. 17 depicts an illustration of a system for the treatment of PFAS-contaminated containers, in accordance with certain embodiments of the present disclosure.

FIG. 18 depicts a block diagram of a system for treating contaminated soil with a mineralization system, in accordance with certain embodiments of the present disclosure.

### DETAILED DESCRIPTION OF THE INVENTION

The present disclosure relates to system and methods for using foam fractionation to remove a PFAS contaminant from a water source. In accordance with one or more embodiments, the systems and methods disclosed herein relate to the separation, concentration, and destruction of PFAS from a source of water that is contaminated with PFAS.

As discussed above, the man-made PFAS chemical compounds are highly stable because of the mentioned carbon-fluorine bonds, which are longstanding and do not readily decompose in the environment. Additionally, PFAS—especially PFAS from products in which it was used as a repellant and protective coating—has cumulated in various water supplies. Even with largescale efforts to phase out the use of PFAS compounds, elevated levels of the “forever chemicals” remain present throughout the environment. PFAS may be found in areas near prevalent uses of prior PFAS products (such as near fire training facilities) and in locations where PFAS has migrated through water and air.

In some non-limiting embodiments, prevalent PFAS, such as PFOS and PFOA, may be removed from water using the methods and systems disclosed herein.

Additionally, based on the EPA's revised guidelines published in May 2016 and recent regulation efforts, water distribution and filtering facilities are now aware of the limits of a combined lifetime exposure of 70 parts per trillion (ppt) for PFOS and PFOA. In some cases, the systems described herein can maintain a concentration of PFAS in treated water to be below the regulated and advised levels.

In certain embodiments, the overall process, can be characterized by taking a PFAS-concentration of at least 100 ppm PFAS by weight (in some embodiments at least 500 ppm or at least 1000 ppm PFAS) to 1 ppm or less, or 0.1 ppm or less, or 0.01 ppm or less. Alternatively, by taking a PFOA-concentration of at least 100 ppm PFOA by weight (in some embodiments at least 500 ppm or at least 1000 ppm PFOA) to 1 ppm or less, or 0.1 ppm or less, or 0.01 ppm or less, or 1.0 ppb or less, or 0.1 ppb or less, or 0.01 ppb or less PFOA; in some embodiments in the range of 1 ppm to 5 ppt (part per trillion) PFOA. Alternatively, by taking a PFOS-concentration of at least 100 ppm PFOS by weight (in some embodiments at least 500 ppm or at least 1000 ppm PFOS) to 1 ppm or less, or 0.1 ppm or less, or 0.01 ppm or less, or 1.0 ppb or less, or 0.1 ppb or less, or 0.01 ppb or less PFOS; in some embodiments in the range of 1 ppm to 5 ppt (part per trillion) PFOS. The process can also be characterized by the same levels of destruction beginning with a PFAS concentration of less than 100 ppm. In some embodiments, PFAS-contaminated water comprising at least 1000 ppt of at least one (or at least 3 or at least 4 or at least 5 or at least 6) compound selected from the group consisting of PFHxA (perfluorohexanoic acid), PFHpA (perfluoroheptanoic acid), PFOA, PFBS (perfluorobutane sulfonate), PFHxS (perfluorohexane sulfonate), PFHpS (perfluoroheptane sulfonate), and PFOS and combinations thereof, treated by the process is (are) reduced by at least 2 (or at least 3 or at least 4 or at least 5) orders of magnitude. In some embodiments, PFAS-contaminated water comprising at least 100 ppt of at least one (or at least 3 or at least 4 or at least 5 or at least 6) compound selected from the group consisting of PFBA (perfluorobutanoic acid), PFPeA (perfluoropentanoic acid), PFHxA, PFHpA, PFOA, 6:2 FTS (6:2 fluorotelomer sulfonate), and 8:2 FTS (8:2 fluorotelomer sulfonate) and combinations thereof, treated by the process is (are) reduced by at least 2 (or at least 3 or at least 4 or at least 5) orders of magnitude and/or reduced to 5 ppt (or 1 ppt) or less.

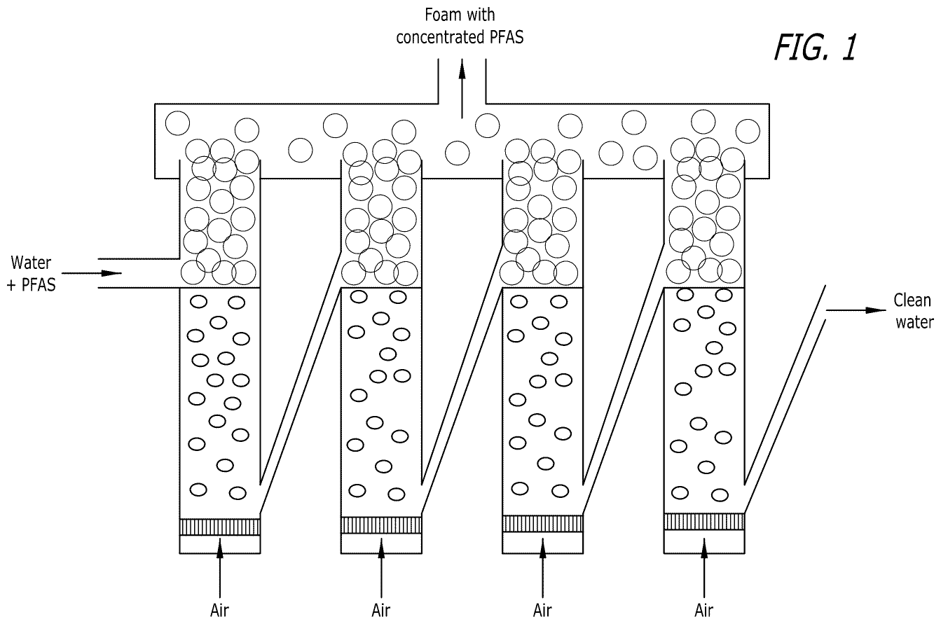

FIG. 1 depicts a continuous foam fractionation system for use with water contaminated with PFAS, in accordance with certain embodiments of the present disclosure.

In some embodiments, separation of PFAS from a source of contaminated water may be achieved using foam fractionation. In such an embodiment, and in accordance with the system shown in FIG. 1, hydrophobic molecules-including the PFAS molecules contaminating the water—can be removed and extracted as a foam. Specifically, in such an embodiment, air can be introduced to a container to produce gas bubbles. In some embodiments, the container is a column, a tank, a vessel, a tube, or combinations thereof. In embodiments of the present disclosure, multiples containers are utilized in order to allow for continuous foam fractionation. In the embodiment of FIG. 1, the configuration allows for air to rise through of contaminated water. In such an embodiment, as air rises through the contaminated water bubbles may be formed. Such bubbles, in this embodiment and as depicted in FIG. 1, allow for the removal of hydrophobic molecules. In such an embodiment, the bubbles will have an air-water interface with a large surface area. The groups on PFAS molecules adsorb to the bubbles of the foam and form a surface layer enriched in PFAS that can subsequently be removed.

In some embodiments, the gas introduced to the system of FIG. 1 may be compressed air or nitrogen. In other embodiments, the gas introduced to the system can be an oxidizing gas, such as ozone.

In some embodiments, the gas is introduced from the base of the container that houses the contaminated water. Further, in some embodiments, the pressure of the container can operate to facilitate the movement of the gas bubbles through the contaminated water and help to form a foam layer.

FIG. 1 shows that the initial inlet in the fractionation column can operate as a point of entrance for a feed stream, where the feed stream contains both water and the PFAS contaminant. As further shown in FIG. 1, the introduction of air from the base of the fractionation column can rise to cause bubbles to propel through the feed in the container and ultimately cause the collection of foam concentrated with the PFAS contaminant at the top of the system of FIG. 1.

FIG. 1 also shown that the feed outlet in one fractionation column can be operatively connected to allow the feed stream to immediately feed into the next fractionation column. In some embodiments, the feed outlet is placed at an upper region of each fractionation column.

Further, as depicted in FIG. 1, in some embodiments, at the top of each fractionation column, there can exist an outlet that allows the feed stream to flow from one foam fractionation column to the next. In some embodiments, the system can include a series of fractionation columns, which can be used to increasingly purify the water by the continuous foam fractionation. In such an embodiment, the PFAS in feed stream will be repeatedly gathered as the feed stream passes through each column. In such an example, the feed stream entering the system will have an initial concentration of PFAS. Following, after the feed stream passes through the first foam fractionation column, the feed stream, which now may be referred to as the purified stream, will have a lower concentration of PFAS. In such an embodiment, this is because many of the PFAS molecules have been removed and isolated in the foam that rests atop the purified stream. Thus, as mentioned, in such embodiments, the concentration of PFAS in the purified stream exiting each column will be lower than that of the feed stream that initially entered the column.

Further, in some embodiments, the system can discharge the feed stream, which can then be referred to as the cleaned stream, once it has a sufficient amount of the PFAS removed. For example, in some embodiments, the cleaned stream can be removed from the system when there is less than 70 parts per trillion (i.e., below the regulatory recommended amount from the EPA's guidance) of PFAS remaining in the cleaned stream. In certain embodiments, the final amount of PFAS left in the cleaned stream may be 1 ppm or less, or 0.1 ppm or less, 0.01 ppm or less, 0.001 ppm (1 ppb) or less, 0.0001 ppm (0.1 ppb) or less, 0.00001 ppm (0.01 ppb) or less, or 0.000001 ppm (0.001 ppb or 1 ppt) or less.

As is also shown in FIG. 1, the system can also include a final outlet that can discharge the feed stream. In some embodiments, the cleaned stream, which will include primarily water or aqueous solution, once discharged from the final outlet of the system may be released back into the environment. In such an embodiment, the cleaned stream can contain minimal amounts of PFAS, such that the concentration of PFAS in the cleaned stream does not pose a risk to humans, animal, or wildlife that the water source may reach once back in the environment.

In the embodiment depicted in FIG. 1, the process can be a fully continuous, multistage process. In such an embodiment, the process can have a high throughput. Further, such an embodiment presents the benefit of having an unlimited scalability, where the process can be used on a small scale for testing small portions of potentially contaminated water, or on a large scale where vast amounts of contaminated water may be run through the continuously run system. Because of the continuous foam fractionation, the system depicted in FIG. 1 may be easily operated without the need for excessive interaction and invention from operators of the system.

In some embodiments, the system as depicted in FIG. 1 may include a feed stream that has an effective amount of a surfactant added therein. In such an embodiment, the surfactant can interact with the PFAS contaminant to create a complexing agent. Accordingly, such a system may be utilized to effective remove light PFAS from a contaminated water source. For example, light PFAS, referring to PFAS with C-4 or less, which may not rise in a standard foam fractionation process may be removed in an enhanced manner through the use of such surfactant. Specifically, in such an embodiment, the light PFAS foam layer comprises the complexing agent. Surfactants may be introduced at different locations. For example, in some embodiments, the surfactants may be introduced prior to the feed stream entering the column. In other embodiments, the surfactants may be introduced to a purified stream in a series of active columns. Moreover, in some embodiments, the system may include multiple surfactant addition points, where the surfactants are added to the feed stream, the purified stream, or combinations thereof.

In some embodiments, where the later columns in the system generate an insufficient amount of foam due to depletion of surfactant from the feed stream in the earlier columns, the system and process can further include adding additional surfactant into various columns throughout the system, which ensures that sufficient surfactant is present in all columns of the system. In such an embodiment, there can be a significant benefit of allowing for the addition of more columns to the system. Accordingly, in some embodiment, the foam fractionation system include ports for surfactant addition throughout the foam fractionation columns to achieve the target separation.

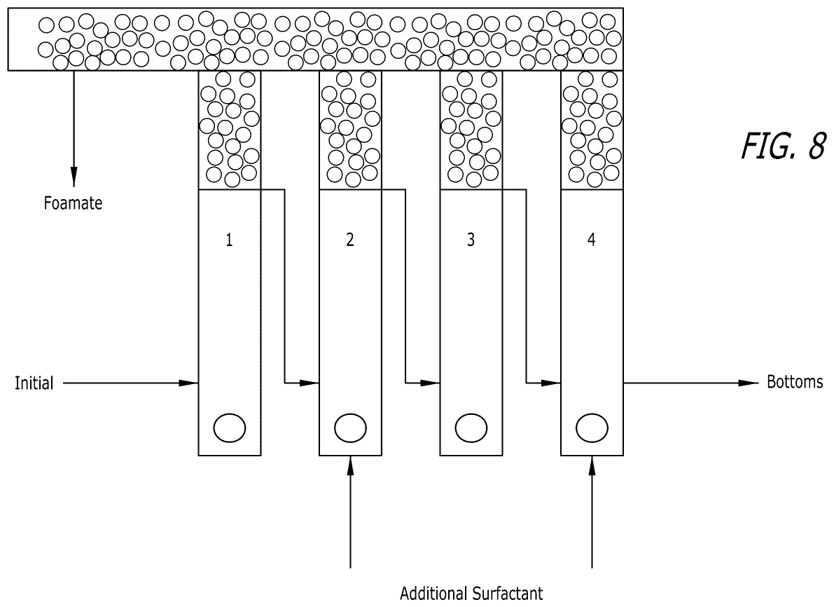

As shown in FIG. 8, which depicts a foam fractionation system with ports for adding additional surfactant, in accordance with certain embodiments of the present disclosure, the ports may be installed into a certain number of columns. For example, and as shown in FIG. 8, the ports for adding surfactant may be added into every other column. The addition of surfactants at the ports can allow for the volume of foam produced can be optimized in each stage. In some embodiments, different surfactant amounts and/or types may be injected at different points.

In some embodiments, surfactants can also be effectively utilized for the destruction of AFFF. In such embodiments, by introducing specific surfactants at various stages within the foam fractionation system, the breakdown and removal of these contaminants in AFFF can be significantly enhanced. The surfactants can be particularly useful in treating the complex mixture of pollutants found in AFFF, ensuring that PFAS levels are reduced to safe limits before the treated water is reintroduced into the environment.

In some embodiments of the system, once a contaminated water source is identified, the contaminated water source is then fed to the system in a feed stream, as is shown in FIG. 1 and discussed above. Further, in this embodiment, the feed stream once in a foam fractionation column may be super-saturated with air. In such an example, the air can be pumped, injected, or flowed through the contaminated water in the foam fractionation column. Because the feed stream is super saturated, the air bubbles rise through the water, while proteins, amphipathic species, and contaminants adsorb to the surface of the air bubbles. In such an embodiment, the air bubbles can then collects as a foam on top of the feed stream in the foam fractionation column.

In some embodiments, the system of FIG. 1 may be utilized with pH and/or ionic strength adjustments. In such an embodiment, particular additives may be added to the feed stream entering the system in order to control the system at a particular operating pH. In certain embodiments, being used either in conjunction with the pH control additives or independently, particular additives may be added to the feed stream entering the system in order to control the system at a particular operating ionic strength. In such an example, the system of FIG. 1 may be used not only with ground water from PFAS contaminated locations, but also with highly contaminated streams containing large amounts of inorganics in addition to PFAS.

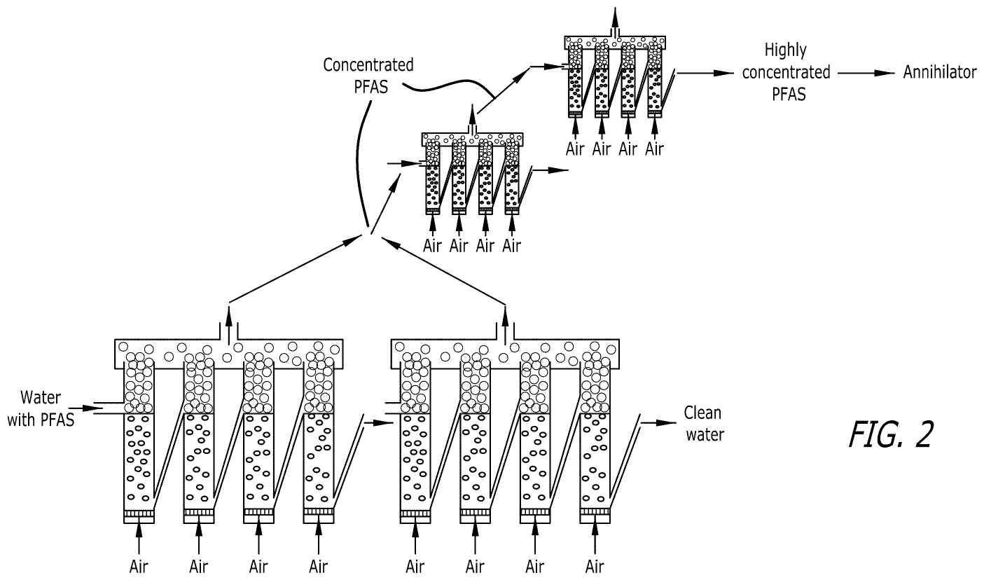

FIG. 2 depicts a process for removing and disposing of concentrated PFAS using a continuous foam fractionation system for use with water contaminated with PFAS, in accordance with certain embodiments of the present disclosure. In such embodiments as shown in FIG. 2 the foam collected from the initial system as shown in FIG. 1 may be further run through continuous fractionation systems. For example, the stored and collected PFAS contaminates collected in the foam layer of one process may then be run through the inlet of a further foam fractionation system having similar characteristics, structure, and conditions as those described in accordance with FIG. 1. In some embodiments, the concentrated PFAS entering a foam fractionation continuous, multistage system may enter the system and then a highly concentrated PFAS may be collected in the foam layer of that system. In some embodiments, once the PFAS is highly concentrated, the PFAS may then be sent to a device for permanent destruction. For example, the PFAS may be sent to a supercritical water oxidation method.

In some embodiments, the foam fractionation system of FIG. 2 may include different arrangements of foam fractionation columns that are tailored to specific requirements. In certain embodiments, the specific requirements are pre-determined.

In some embodiments, the specific requirements include, but are not limited to, the amount of wastewater to be processed, the flow at which the processing needs to be carried out, and a degree of PFAS concentration required.

There can be a variety of possible arrangements for the process, one embodiment of such process shown in FIG. 2. As shown in FIG. 2, eight foam fractionation columns can be used to treat the incoming water contaminated with PFAS and to convert it to clean water. As also shown in FIG. 2, the foam produced by these columns can be further treated in two groups of foam fractionation columns, for example with each consisting of four columns. In embodiments where there are large amounts of wastewater to be treated, the process may use additional columns connected in parallel.

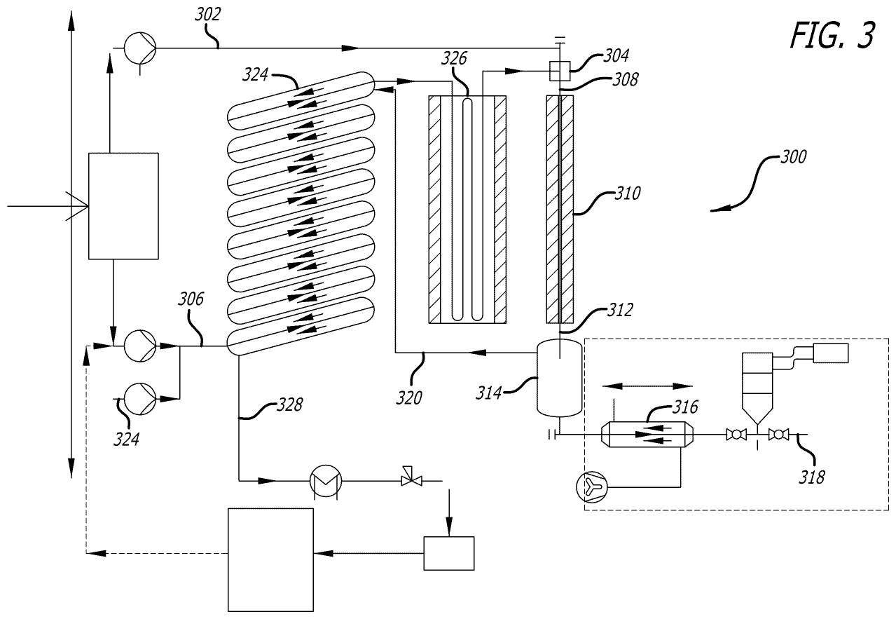

FIG. 3 depicts a supercritical water oxidation method for use in a process for removing and disposing of concentrated PFAS using a continuous foam fractionation system for use with water contaminated with PFAS, in accordance with certain embodiments of the present disclosure. The disclosure and teachings of U.S. Pat. No. 11,401,180 B2, entitled “Destruction of PFAS via an oxidation process and apparatus suitable for transportation to contaminated sites” are incorporated by reference in their entirety.

A preferred system 300 is illustrated in FIG. 3. In the embodiment of FIG. 3, PFAS-contaminants 302, as can be extracted by the system of FIGS. 1 and 2, enters mixing tee 304. In certain preferred embodiments, the PFAS-contaminants enters the tee at ambient conditions (room temperature) or relatively low temperature so that the inlet line is not corroded. In the mixing tee, the PFAS-contaminants 302 are mixed with hot, clean water 306, which may be, for example, 650° C. The combined stream can be at a combined temperature.

The oxidant 324 can be in either stream 302 or 306. In preferred embodiments, the oxidant 324 is in stream 306 to prevent premature reaction. Combined stream 308 passes into Supercritical Water Oxidation (SCWO) reactor 310. In some embodiments, the SCWO reactor 310 is a vertical tube, in respect to gravity, surrounded by insulation and heating means for start-up. Temperature in the SCWO reactor 310 in certain embodiments is in the range of 500 to 700° C.

The effluent 312 can passes into a salt separator 314 where salt can be removed manually or through exhaust system 316. In such an embodiment, the system is left as brine 318. Salt can be a mixture of sodium chloride, sodium fluoride, sodium sulfate, sodium nitrate or corresponding salts of other alkali or alkaline earth elements.

Fluid 320, in certain embodiments, leaves the separator and is routed through a heat exchanger 322, in the direction indicated such that temperature of fluid 320 is highest where the clean water 306 leaves the heat exchanger.

In some embodiments, after passing the heat exchanger, the clean water 306 may optionally be passed through heater 326 to heat the water to 600° C. or higher. After passing through the heat exchanger, effluent 328 can leave the system and optionally be neutralized at any point after exiting the SCWO reactor 310. In some embodiments, all or a portion of the effluent can also be recycled into the system and/or released into the environment or a water treatment facility.

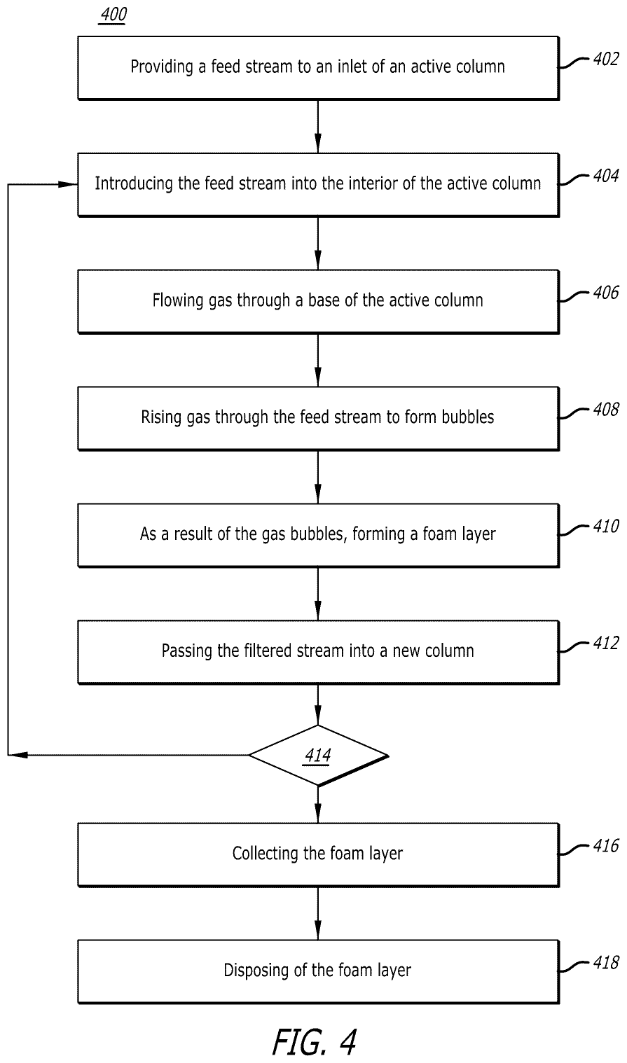

Referring to FIG. 4, which depicts a block diagram of a method for using a continuous foam fractionation system to treat water contaminated with PFAS, the method may be initiated by determining a water source containing contaminants. In certain preferred embodiments, a water source that has been contaminated with PFAS is identified. For example, in some embodiments, the water source may be contaminated with PFOS or PFOA, or combinations thereof. In some embodiments of the present disclosure, the method may be used to isolate and identify whether a suspected water source does in fact contain PFAS.

As shown in FIG. 4, method 400 beings at step 402. At step 402, the method includes providing a feed stream to an inlet of an active column. In some embodiments, the feed stream can include a PFAS contaminant. In some embodiments, the feed stream may predominately include water or an aqueous solution. In certain embodiments, the feed stream may include organic contaminants, inorganic contaminants, or combinations thereof. In certain embodiments, the feed stream may include one or more additives. For example, the feed stream can include additives allowing for the feed stream to be at a set pH. In another example, the feed stream can include additives that allow for the feed stream to have a particular ionic strength.

At step 404, the method includes introducing the feed stream into an interior of the active column. For example, in such an embodiment, the feed stream can be housed within a column for foam fractionation. At step 406, the method includes flowing gas through a base of the active column into the interior of the active column. In some embodiments, the gas may be introduced via a porous gas nozzle. In certain embodiments, the gas may be introduced via a venturi device where the compressed gas drives water flow, which in turn can mix the gas and water streams. In other embodiments, the gas may be introduced via a water vacuum pump device where water flow generates suction that introduces gas stream into a water stream. Moreover, in some embodiments, the gas can be introduced near an impeller, a mixer, or a combination thereof to generate gas-water mixing.

The gas, in certain embodiments, may be compressed air, oxygen, nitrogen, carbon dioxide, or combinations thereof. In some embodiments, the gas may be any gaseous phase chemical composition that will allow for contaminant adsorption on the surface of gas bubbles of the gas.

At step 408, the method includes, as a result of the flowing of the gas into the interior of the active column, rising gas through the feed stream in the interior of the active column to form gas bubbles in the feed stream.

At step 410, as a result of the gas bubbles in the feed stream, the method includes forming a foam layer. In some embodiments, the foam layer is situated atop the feed stream in the interior of the active column. In certain embodiments, the foam layer can include at least a part of the PFAS contaminant that was initially present in the feed stream. After the foam layer is formed, in some embodiments, the interior of the active column can include both the foam layer and a purified stream, where the purified stream is the result of the PFAS contaminant being removed from the feed stream.

At step 412, the method includes passing the purified stream into a next column. In some embodiments, the next column operates as the active column and the purified stream operates as the feed stream.

Following, at decision block 414, the method progresses to determine whether the solution flowing through the system as the filtered stream contains a sufficiently low level of contaminant to result in a cleaned stream. In some embodiments, the decision block 414 determinations are decided prior to the construction of a system for conducting the method 400. In such an embodiment, the calculation of the quantity of PFAS contaminant removed at each column can be performed. In this embodiment, based on the calculation, the system is designed to contain the number of columns that will achieve a cleaned stream containing a sufficiently low level of contaminant. Such an embodiment will have a static number of columns that the feed stream and/or filtered stream will pass through in the system.

If the decision at block 414 is negative (i.e., the purified stream contains an amount of PFAS that may pose a health risk or is greater than a pre-determined amount of PFAS contaminant), then the method restarts at step 404.

If the decision at block 414 is affirmative (i.e., there is a sufficiently minimal amount of PFAS remaining in the purified stream such that the water in the stream does not pose either a health risk or is less than a pre-determined amount of PFAS contaminant), then the method continues to step 416. In some embodiments, as the number of columns in the system performing the method is predetermined, the decision at block 414 does not change the architecture of the system performing method 400.

At step 416, the method includes collecting the foam layer. At step 418, the method includes disposing of the foam layer.

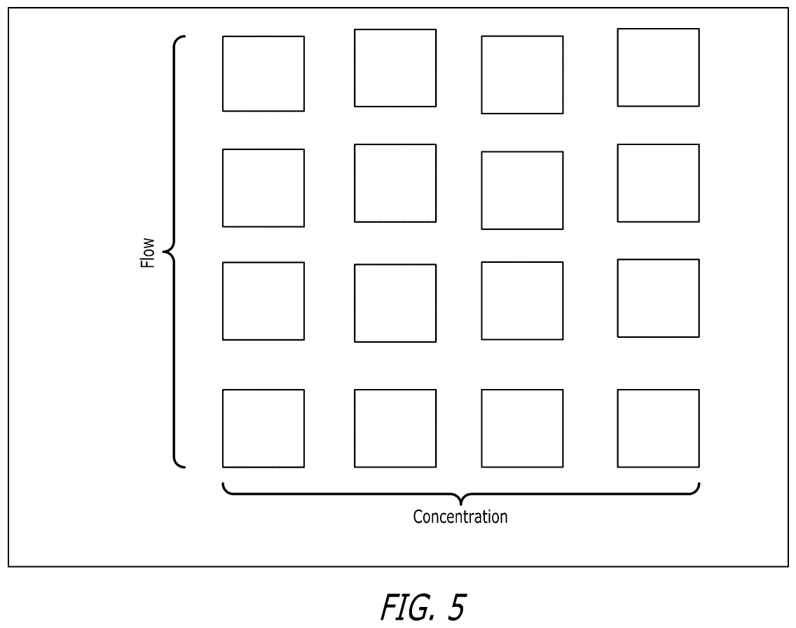

FIG. 5 depicts a diagram of a modular system that allows for flexibility in flow and concentration based on capabilities and needs of a system, in accordance with certain embodiments of the present disclosure.

As shown in FIG. 5, the foam fractionation process may be utilized in a flexible and modular system. For example, in some embodiments and as shown in FIG. 5, the system can be physically adjusted to meet specific pre-determined needs. Such flexibility allows for adjustment without the need for expensive redesign and rebuilding of an entire foam fractionation system.

The number of systems in parallel determines the total flow capacity, as shown in FIG. 5. Further, as shown in FIG. 5, the number of systems in series determines the total concentration.

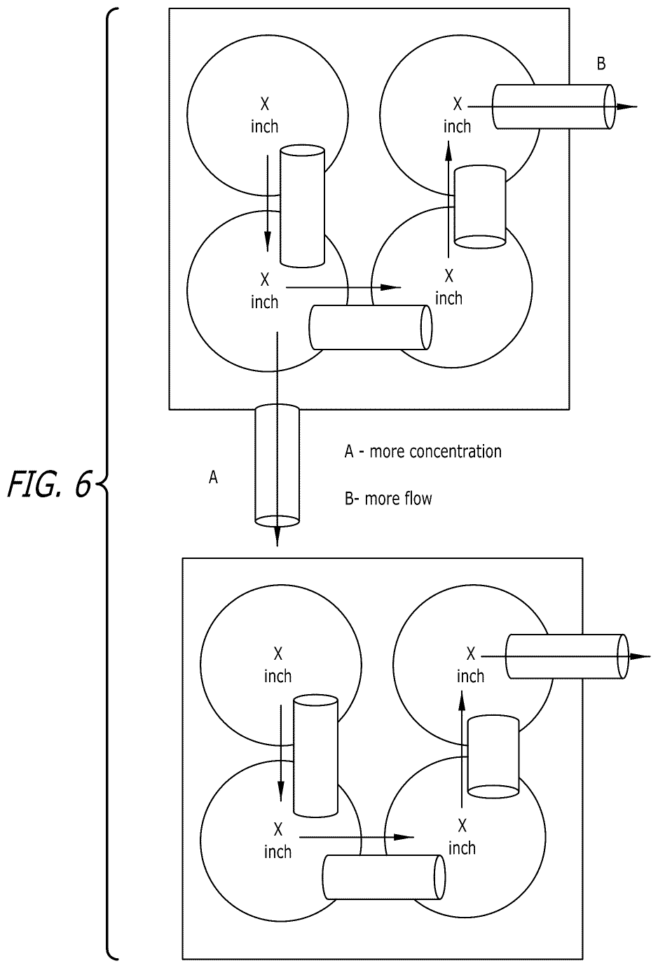

FIG. 6 depicts a diagram of a system that allows for flow routing using a plurality of inlet ports, in accordance with certain embodiments of the present disclosure.

In some embodiments, as shown in FIG. 6, the system can allow for the flow to be routed based on the use of a plurality of inlet ports, where the number of inlet ports utilized affects the flow. Further, as shown in FIG. 6, the system can allow for the concentration of the PFAS in the foam to be increased based on routing the flow from the flexible foam fractionation system through additional stages in the multistage process. Further, as shown FIG. 6, the use of multiple inlets B and the use of multi-stage connections. A through process columns with diameters X can allow for increased flow and increased concentration, respectively.

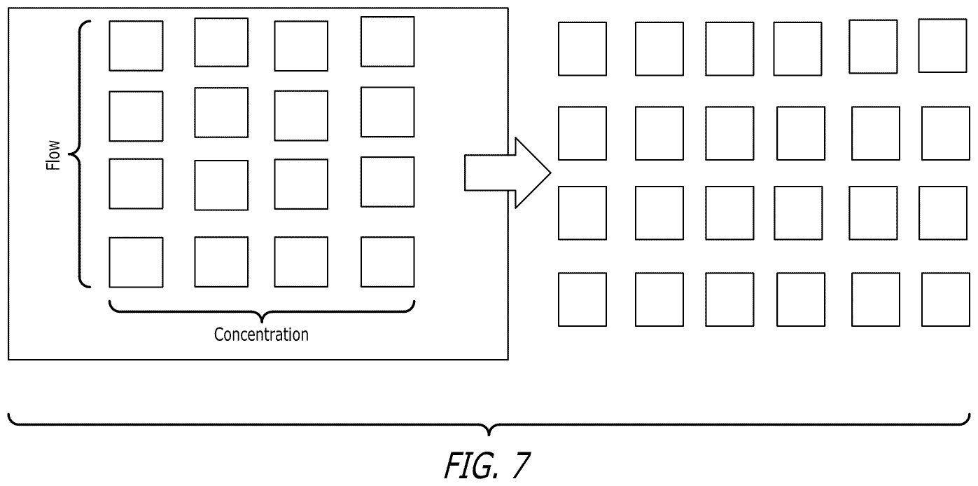

FIG. 7 depicts a diagram demonstrating the ability to increase concentration in system that allows for the modular components in a system flexible foam fractionation to be removed from a housing, in accordance with certain embodiments of the present disclosure.

In certain embodiments, the system can include modular components that may be freely movable, such that the modular components allow portions of the foam fractionation system to be taken out of a housing and expanded in number to increase flow or concentration as needed on site. In such an embodiment, the process can involve placing the foam fractionation columns on modular skids that can be fit into housings and taken out as needed. As shown by FIG. 7, removing the foam fractionation columns and portions of the system from a particular housing may allow for increased concentration.

In some embodiments, the system for foam fractionation can include a containerized system with external skids. Such a system could be deployed to increase either concentration or flow. Further, such an embodiment can be utilized to provide temporary increase in capability. In some embodiments, the system could be utilized to progressively increase the capacity of a system as need increases. Moreover, in some embodiments, the system may increase concentration where destruction is not available to save on storage space until destruction of the PFAS contaminants is available.

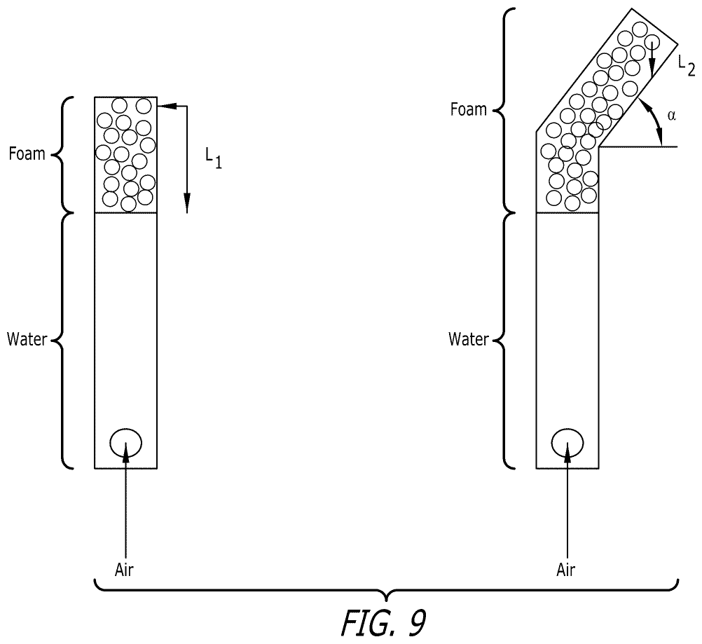

FIG. 9 depicts an angled foam fractionation column, in accordance with certain embodiments of the present disclosure.

As shown earlier in respect to FIG. 1, in some embodiments, the foam fractionation columns are vertical. In such embodiments, compressed air is injected into the liquid phase at the bottom of the column, which generates a foam that rises to the top. Further, in such embodiments, as the foam travels upward, extra water may travel with it leading to a wet foam (i.e., a foam that has retained a significant amount of water).

In some embodiments, to increase effective foam fractionation, the process can produce and utilize a relatively dry foam. A dry foam can increase the efficiency of the foam fractionation because the concentration of the target molecules in the foamate is maximized when the volume of water is minimized. Moreover, drainage from bubble breakage increases solute concentrations in the foam due to the elevated solute concentrations in liquid that originates from bubbles.

Accordingly, as shown in FIG. 9, in some embodiments, the foam fractionation system can include angling of the top portion of the foam fractionation columns. As shown in FIG. 9, when the top portion of the column is installed at an angle, a, the vertical distance a retained water molecule needs to travel to reach either the liquid phase or the wall of the column is decreased (L2<L1). In such an embodiment, this decrease facilitates the drainage of water from the foam, leading to more concentrated foamate. In certain embodiments, angle, a, is 450 as is shown in FIG. 9. This angle can be convenient to implement since pipe fittings facilitating 45° are commercially available.

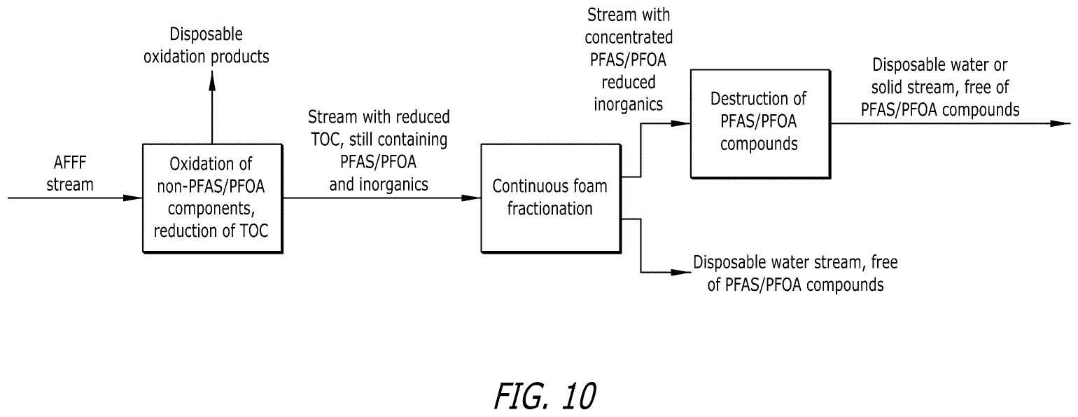

FIG. 10 depicts a process diagram for the destruction of AFFF, in accordance with certain embodiments of the present disclosure. The process for destroying AFFF addresses the challenge of multiple pollutants present in AFFF at high concentrations. In a highly contaminated source, such as AFFF, the contaminants other than PFAS or PFOA, such as total organic carbon (TOC), can result in creating an exothermic or corrosive environment during the PFAS destruction process. Accordingly, the process of FIG. 10 can be utilized to destroy non-PFAS contaminants through oxidation processes, which can allow for destruction of PFAS using supercritical water oxidation or mineralization using metal oxides in a less exothermic and corrosive manner.

As shown in FIG. 10, the process for destroying the AFFF may begin with the introduction of an AFFF stream. After introducing the stream, the process as depicted in FIG. 10 can include the oxidation of non-PFAS compounds in the AFFF stream. In some embodiments, the oxidation approaches can include, but are not limited to, the use of ultraviolet (UV) radiation, the use of ozone, the use of hydrogen peroxide, the use of sodium persulfate, the use of phosphoric acid, or combinations thereof.

The process of FIG. 10 may also include a recycle stream to quench or dilute the feed. In such an embodiment, the oxidation can further eliminate the oxidizable contaminants preventing a build-up of these contaminants in the recycle loop. In certain embodiments, the introduced stream containing the PFAS contaminant can be diluted to such a level as to be able to measure incoming TOC. In such an embodiment, an applied amount of UV can be applied to reduce the TOC content.

In certain embodiments, the UV would include oxidants. In some embodiments, the process can include using a UV (185 nm) with peroxide or ozone. In other embodiments, the UV can be used without oxidants. In some embodiments, the process can include using a UV (185 nm) solely. In other embodiments, the process may include using UV emitting 15 nm to 220 nm with ammonium or sodium persulfate.

In some embodiments, the oxidation step can leave all or most of PFAS compounds in their original form but will decompose the non-PFAS surfactants and solvents present in the AFFF. In certain embodiments, the oxidation does not affect inorganic materials that may be introduced by use of hard water in AFFF formulations.

Following the oxidation, as shown in FIG. 10, the process may continue with a foam fractionation-based separation and concentration of PFAS compounds, as described in FIGS. 1, 2, and 4 above. In some embodiments, the foam fractionation can utilize co-surfactants that enhance PFAS concentration, such as for example surfactants that simultaneously suppress concentration of inorganic materials. The supercritical oxidation method is sensitive to presence of inorganics since these form solid deposits and particulates in the supercritical water environment.

As discussed in respect to FIGS. 1, 2, and 4 above, and as shown in FIG. 10, in some embodiments, the foam fractionation process can produce two streams, where the first stream is a highly concentrated PFAS stream or foam, and the second stream is a disposable water stream free of the PFAS compounds.

For the highly concentrated PFAS stream or foam, the process may continue with the destruction of the PFAS compounds by either supercritical water oxidation, in accordance with FIG. 3, or high temperature, low pressure, mineralization using metal oxides with enhancer reactivity.

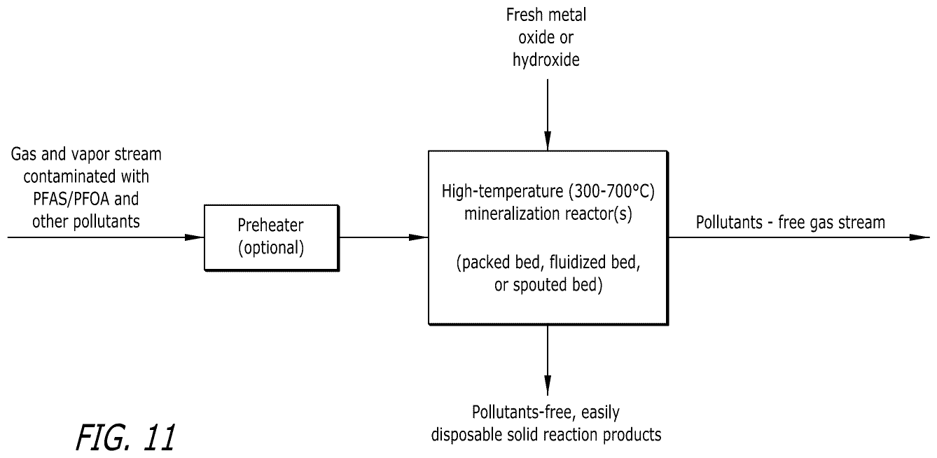

In some embodiments, the disposal of the foam layer is through the treatment of the PFAS/PFOA-contaminated foam stream using a reactive metal oxide. FIG. 11 depicts a schematic continuous process for treating PFAS/PFOA contaminated foam streams with reactive metal oxides, in accordance with embodiments of the present disclosure.

PFAS and PFOA compounds can be decomposed using calcium compounds at moderate temperatures of 300-700° C., with the reaction producing non-toxic calcium fluoride (CaF₂) as a main solid product. The general reaction between PFAS/PFOA compounds and calcium oxide can be described as:

PFAS/PFOA+CaO→CaF₂+H₂O+CO₂+immobilized solid products

In certain embodiments, the reaction does not require elevated pressures and there is no evidence of corrosion caused by formation of hydrofluoric acid (HF).

Furthermore, the synthesis of calcium oxide (CaO) with enhanced chemical reactivity can maximize its effectiveness in PFAS destruction. Methods such as thermal decomposition of calcium hydroxide (Ca(OH)₂) at 400-500° C. have been established to produce highly reactive CaO, a crucial factor in efficient PFAS removal.

Accordingly, in embodiments of the present disclosure, calcium hydroxide (Ca(OH)₂) can serve as a decomposing agent for PFAS, and this equivalence enables the development of PFAS destruction processes using both CaO and Ca(OH)₂. Additionally, magnesium oxide (MgO) shares similar chemical properties with CaO, providing an alternative for PFAS removal processes. Reactive MgO can be produced through the thermal decomposition of magnesium hydroxide (Mg(OH)₂) at around 400-500° C., offering potential utility in PFAS elimination.

Significantly, the method of the present disclosure may operates at atmospheric pressure, eliminating the need for high-pressure equipment and associated safety concerns. Furthermore, the risk of corrosion due to hydrofluoric acid (HF) formation can be significantly reduced or eliminated. The mineralization process effectively converts fluorine into CaF₂, a non-corrosive solid, negating the requirement for expensive, corrosion-resistant alloys. Beyond PFAS/PFOA treatment and destruction, this process displays the capability to decompose various toxic compounds, making it suitable for treating complex waste streams containing multiple pollutants.

A general approach to continuously treat PFAS/PFOA contaminated foam streams with reactive metal oxides is presented schematically in FIG. 11. The process, as shown in the embodiment depicted in FIG. 11, is carried out in a high temperature reactor. In some embodiments, the high temperature reactor operates at 300 to 700° C. Further, in embodiments, the high temperature reactor contains metal oxides, preferably reactive forms of CaO or MgO.

In certain embodiments, such as those where incoming stream is delivered at lower temperature, a suitable heater or heat exchanger can be used to pre-heat the foam contaminated with PFAS/PFOA and other pollutants. In other embodiments, heat may be delivered directly to the reactor. Several types of reactors can be used including packed bed, kiln (calciner) fluidized bed, belt furnace, or spouted bed reactors. The reaction can be carried out at any pressure, for example atmospheric or near atmospheric pressure. Assuming the mineralization system is properly designed, the effluent, pollutant-free gas stream can be released directly to atmosphere. In some cases, a gas effluent purification equipment may be used to further reduce possibility of PFAS releases.

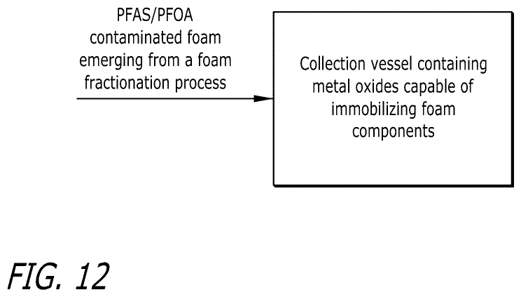

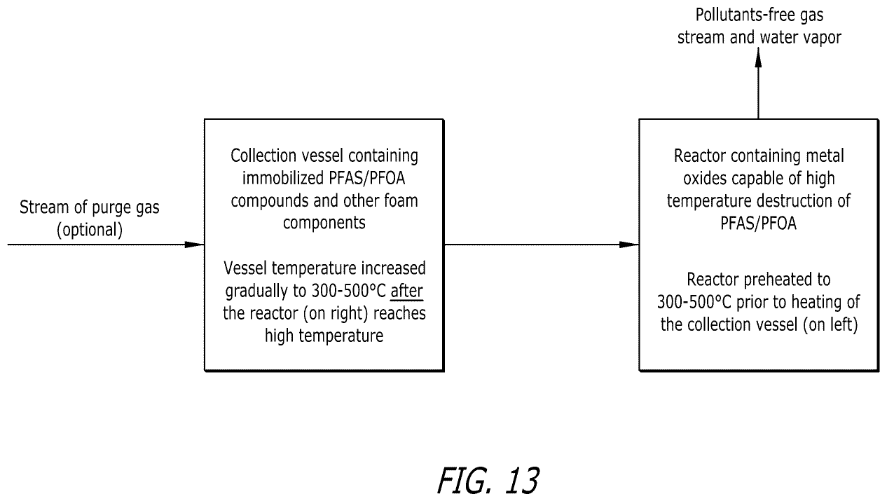

FIGS. 12 and 13 depict a schematic batch process for treating PFAS/PFOA contaminated foam streams with reactive metal oxides, in accordance with embodiments of the present disclosure. Specifically, the batch treatment of PFAS/PFOA-contaminated foam is presented in FIGS. 12 and 13. In certain embodiments, the batch treatment of PFAS/PFOA-contaminated foam is a two-step process consisting of, first as shown in FIG. 12, capture of PFAS/PFOA contaminated foam, and then, second as shown in FIG. 13, the actual destruction of these compounds.

In the first step, shown schematically on FIG. 12, the foam stream from the foam fractionation processes can be introduced into a vessel containing one or more metal oxides, for example but not limited to CaO or MgO.

The vessel can be at room or slightly elevated temperature, which both allow for formation of hydroxides via reaction between metal oxide and water. In such an embodiment, the reaction can effectively convert the foam stream into a solid hydroxide mixed with PFAS/PFOA compounds as well as with other pollutant potentially present in the foam form the foam fractionation process.

In some embodiments, the foam immobilization temporarily converts the foam stream into a solid which can be further treated at a later time. Such temporary storage can be convenient for low volume from streams that can be treated periodically once sufficient quantities are collected. As the reaction between metal oxides and water is exothermic, especially if CaO is used, in some embodiments, the system and method further include the application and use of a suitable heat removal mechanism.

In the second step, shown schematically in FIG. 13, the vessel used to immobilize foam components can be connected to a second vessel, for example a reactor, containing metal oxides capable of high-temperature destruction of PFAS/PFOA. The connection, in certain embodiments, may be made using a pipe or tubing allowing for transfer of hot gases and vapors between the two vessels.

The second vessel containing fresh metal oxide, in preferred in embodiments, is heated first to temperature required for PFAS/PFOA compounds, such as for example but not limited to between approximately 300 to 700° C. Once the oxide is heated to this temperature, the oxide will be highly reactive towards PFAS/PFOA and towards other pollutants. At the same time, the oxide loses its reactivity towards water since it is at above the decomposition temperature of its hydroxide form. Accordingly, in such an embodiment, the metal oxide at high temperature acts effectively as a selective reactor/filter, reacting with pollutants but allowing for free passage of water vapor.

In some embodiments, the release of foam components previously immobilized can be realized by a controlled heating of the collection vessel. The process, for example, can release PFAS/PFOA compounds, other pollutants, water vapor, and combinations thereof.

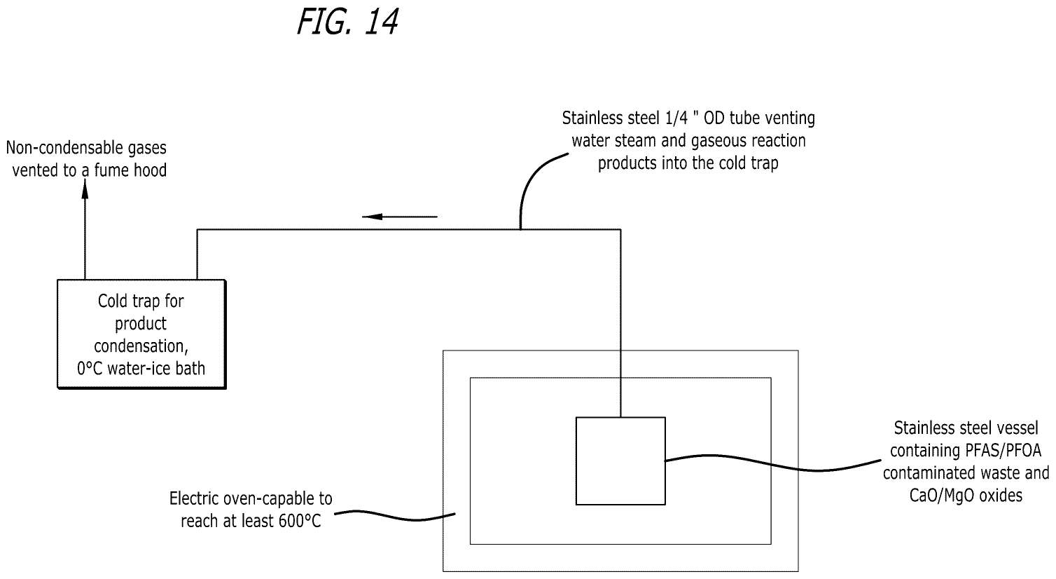

FIG. 14 depicts an apparatus for the PFAS/PFOA mineralization, in accordance with certain embodiments of the present disclosure.

In some embodiments, and as shown in FIG. 14, the PFAS/PFOA-contaminated waste can be mixed with metal oxide and placed in a vessel connected with a vapor trap. In such an embodiment, mineralization may then be carried out using two reaction vessels connected in series. Further, in such an embodiment, the apparatus, in whole or in significant part, can operate at atmospheric pressure. Solids remaining in the vessels and vapors condensed in the cold trap may then be analyzed for PFAS/PFOA content.

As shown in FIG. 14, the PFAS/PFOA mineralization may include an electric or gas-heated oven. The electric oven, in some embodiments, may be capable of reaching temperatures of 600° C. The electric oven, or any exterior vessel for heating in the apparatus, may contain an interior vessel, which in certain embodiments contains PFAS/PFOA-contaminated waste along with CaO oxides, MgO oxides, or combinations thereof.

The apparatus may further contain venting, through for example but not limited to a ventilation tube, for venting water steam and the gaseous reaction products. In some embodiments, and displayed in FIG. 14, the venting tube may lead the water steam and gaseous reaction products into an operatively connected cold trap. The cold trap, as part of the apparatus shown in FIG. 14, facilitates product condensation. The cold trap, in some embodiments, can be a water-ice bath. From the cold trap, the condensed product may be collected, and the non-condensable product may be vented into a fume hood.

In collected condensed product can include solid waste, which will be inorganic salt residue produced by evaporation of the aqueous solution containing PFAS/PFOA pollutants. Accordingly, in some embodiments, the pollutant-free solid reaction products may be easily disposed.

A system for destroying PFAS compounds using mineralization with reactive oxides can be used on a wide variety of PFAS-contaminated waste, including but not limited to, concentrated foam from a foam fractionation system, AFFF, soil, water from washing soil, plastic containers that are contaminated with PFAS, or combinations thereof.

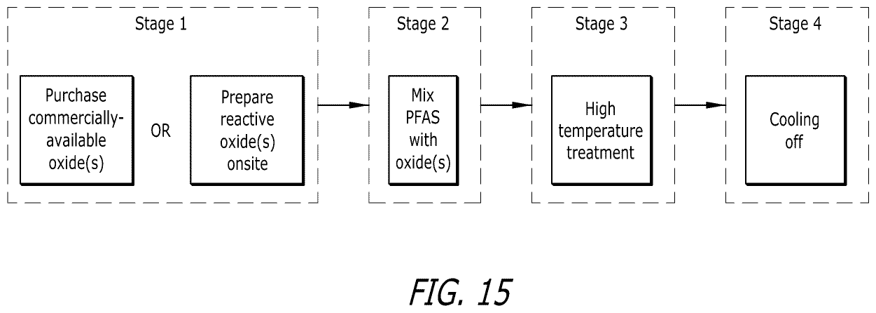

FIG. 15 depicts a block diagram of a system for the destruction of PFAS compounds via mineralization with reactive oxides, in accordance with certain embodiments of the present disclosure.

As shown in FIG. 15, the system for the destruction of PFAS compounds via mineralization with reactive oxides can include four stages: acquisition of reactive oxides, mixture of PFAS-contaminated waste with reactive oxides, high temperature treatment of the oxide/waste mixture, and cooling of the oxide/waste mixture.

In some embodiments, such as the embodiment of FIG. 15, the first stage of the process can include the acquisition of reactive oxides. The reactive oxides may be metal oxides. In certain embodiments, reactive oxides may be obtained by purchasing them commercially or preparing them prior to mineralization. In embodiments where the reactive oxides are prepared onsite, the preparation may be performed through the thermal decomposition of metal hydroxides, such as Ca(OH)₂, Mg(OH)₂, or a mixture thereof. For such embodiments, the preparation may occur at temperatures ranging from approximately 300° C. to approximately 800° C. The reaction, in some embodiments, can take place in equipment such as a batch furnace, belt furnace, kiln (calciner), or fluidized bed.

The next stage of the process, as shown in FIG. 15, can be the mixing of the PFAS-contaminated waste with reactive oxides. In certain embodiments, the mixing can be performed with any conventional mixer. In other embodiments, the mixing may be performed using equipment such as a rotary kiln, such as a calciner, or a fluidized bed.

Following, in the process shown in FIG. 15, the oxide and contaminated waste mixture is treated at a high temperature. In this stage of the process, the PFAS compounds undergo chemical reaction with the oxide rather than incineration or decomposition. In some embodiments, the treatment occurs at a temperature between approximately 400° C. and approximately 650° C. using equipment such as a furnace, belt furnace, or rotary kiln. In certain embodiments, depending on the needs of the system, one or more of such devices might be used. For example, multiple furnaces or kilns might be used in series. In an example embodiment, the process might perform the step mixing in one rotary kiln and then perform the high temperature treatment in a series of multiple connected furnaces, kilns, or combinations thereof.

In the fourth and final block shown in FIG. 15, the process proceeds with the cooling of the oxide and contaminated waste mixture after high-temperature treatment. In some embodiments, the process of cooling the oxide and contaminated waste mixture can occur in the same equipment vessel as that used to perform the high temperature treatment. As an example embodiment, if a belt furnace is used for the high temperature treatment of the oxide and contaminated waste mixture, the belt furnace can simply be turned off to cool the mixture.

In some embodiments, once the mixture has been sufficiently cooled, the mixture can be removed from the system and appropriately disposed of. In some embodiments, the mixing, high temperature treatment, and cooling steps could all be performed within a single equipment vessel, such as a kiln of sufficient length.

The size and type of equipment selected for the process shown in FIG. 15 may vary depending on the volume and identity of the waste streams subject to the treatment. For instance, as an example embodiment, the reactive oxides may be prepared onsite for a large-scale system, whereas it might be more cost-effective to purchase them commercially for a small-scale system.

The process shown in FIG. 15 is compatible with a wide-range of waste sources because of the customizability and scalability of the system and process.

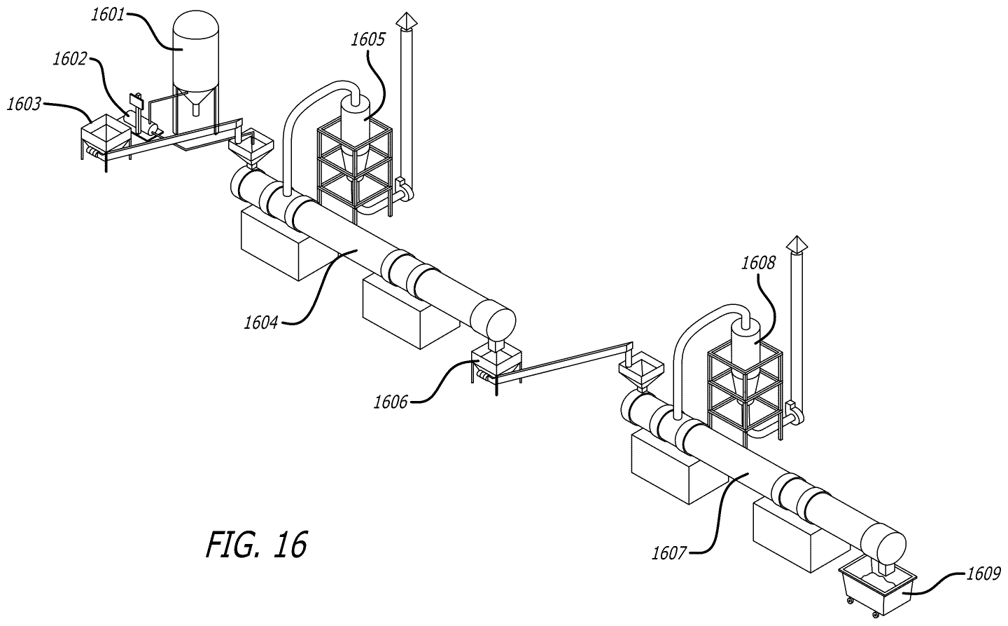

FIG. 16 depicts an illustration of an exemplary embodiment of a system for the destruction of PFAS compounds via mineralization with reactive oxides, in accordance with certain embodiments of the present disclosure.

As shown in the embodiment of FIG. 16, the reactive oxides and PFAS-contaminated waste are combined the oxide tank 1601, connected to the oxide dispersing system 1602 and waste feeder conveyer 1603. Following, in this example embodiment of FIG. 16, the mixture can then be fed into a primary rotary kiln 1604. As shown in FIG. 16, once the oxide and contaminated water mixture has been treated in the primary rotary kiln 1004, the mixture can then be transported on a feeder conveyor 1606 to a secondary kiln 1607 for final processing. After treatment is complete, in the exemplary process of FIG. 16, the mixture can then be sent for disposal at a waste collection receptacle 1609. In the embodiment shown in FIG. 16, the PFAS-contaminated atmosphere from both kilns is captured and treated, in particulate vapor treatment system 1605 and 1608, respectively, to avoid emission to the environment.

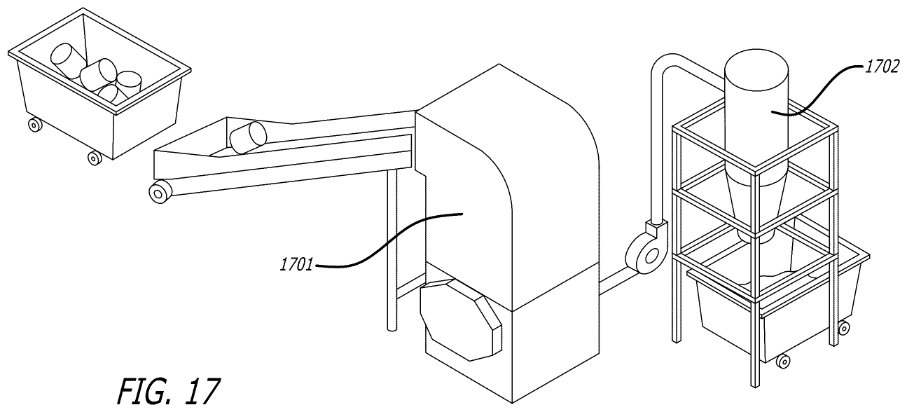

FIG. 17 depicts an illustration of a system for the treatment of PFAS-contaminated containers, in accordance with certain embodiments of the present disclosure.

The system and process of FIGS. 15-16 discussed above can be utilized for the treatment of PFAS-contaminated containers, such as plastic containers used to store AFFF. As such, in some embodiments, solid waste containers can be shred into small pieces to allow for mixing with the reactive oxides in the process of FIGS. 15-16. The treatment of plastic pieces in the high temperature processes of FIGS. 15-16 may result in the decomposition of the plastic, which is distinct from incineration. In some embodiments, the high temperature treatment can be performed at atmospheric pressure.

As shown in FIG. 17, in an exemplary embodiment, the PFAS contaminated containers, such as but not limited to plastic buckets, can be introduced to a shredder 1701, which can thereby reduce the containers into small pieces of plastic. These shredded pieces of the containers, in such embodiment, may be kept in a closed storage system 1702 to minimize the hazards associated with plastic dust and PFAS emissions. From the storage system, the shredded contaminated container pieces can be transported to the system described in FIG. 15 and illustrated in FIG. 16, in which the shredded contaminated container pieces can be mixed with reactive oxides before receiving high temperature treatment.

As such, in some embodiments, the treatment of these plastic pieces in this system can occur through a high-temperature process, distinct from incineration. In some embodiments, such a high-temperature process may be performed at atmospheric pressure. This high-temperature treatment can then result in the decomposition of the plastic, contributing to the effective management of PFAS-contaminated materials. Such process represents can be utilized as a safe, environmental responsible, and efficient treatment for contaminated materials.

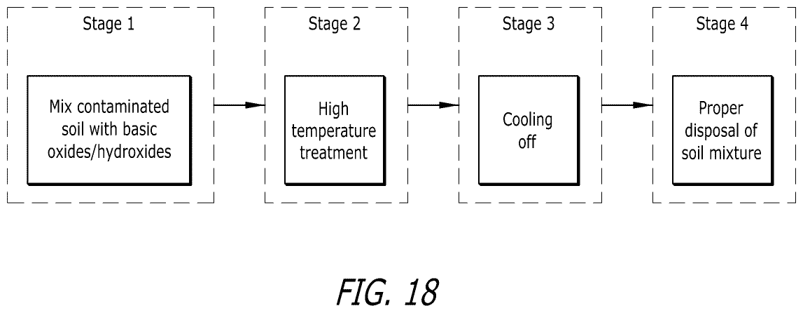

FIG. 18 depicts a block diagram of a system for treating contaminated soil with a mineralization system, in accordance with certain embodiments of the present disclosure.

The system and process of FIGS. 15-16 discussed above can be utilized for the treatment of highly contaminated soil for re-use. In such embodiments, the process as described in FIG. 18 operates optimally with a small quantity of highly contaminated soil, such as for example but not limited to a pile on a worksite. In certain embodiments, the process uses direct treatment of the contaminated soil.

As shown in FIG. 18, the process can begin with thoroughly mixing highly contaminated soil with oxides, hydroxides, or a combination thereof. Following, as shown in the next block in FIG. 18, the mixture can then be placed into a high temperature treatment unit. In some embodiments, the high temperature treatment unit is a batch oven, which would allow for chemical decomposition of the PFAS. In other embodiments, the high temperature treatment unit may be a kiln, fluidized bed, or combination thereof. As shown in FIG. 18, upon the completion of treatment, the mixture can then cool before being disposed of in a safe and environmentally conscious manner.

Consistent with the above disclosure, the examples of systems and methods enumerated in the following clauses are specifically contemplated and are intended as a non-limiting set of examples.

Clause 1. A method for using foam fractionation to remove a PFAS contaminant from a water source, the method includes providing a feed stream to an inlet of an active column, where the feed stream comprises the PFAS contaminant and water; introducing the feed stream into an interior of the active column; flowing gas through a base of the active column into the interior of the active column; as a result of the flowing of the gas into the interior of the active column, rising gas through the feed stream in the interior of the active column to form gas bubbles in the feed stream; as a result of the gas bubbles in the feed stream, forming a foam layer, wherein the foam layer is situated atop the feed stream in the interior of the active column, the foam layer comprises at least a part of the PFAS contaminant, and after the foam layer is formed, the interior of the active column comprises the foam layer and a purified stream; passing the purified stream into a next column, wherein the next column operates as the active column and the purified stream operates as the feed stream; continuously repeating foam fraction steps until the feed stream becomes a cleaned stream, wherein a cleaned stream comprises water and at or below a final concentration of the PFAS contaminant; collecting the foam layer; and disposing of the foam layer.

Clause 2. The method of any foregoing clause further including adding an effective amount of a surfactant to the feed stream.

Clause 3. The method of any foregoing clause further comprising, after collecting the foam layer, utilizing the foam layer as the feed stream.

Clause 4. The method of any foregoing clause further including interacting the surfactant the PFAS contaminant to create a complexing agent, where the foam layer comprises the complexing agent.

Clause 5. The method of any foregoing clause, where the PFAS contaminant in the feed stream has an initial PFAS concentration, the at least a part of the PFAS contaminant in the foam layer has removed PFAS concentration, and a remaining PFAS contaminant in the cleaned stream has a final PFAS concentration.

Clause 6. The method of any foregoing clause, where the initial PFAS concentration is equal to that of the removed PFAS concentration added to the final PFAS concentration, and where the removed PFAS concentration is greater than or equal to the final PFAS concentration.

Clause 7. The method of any foregoing clause, where the foam fractionation is continuous.

Clause 8. The method of any foregoing clause, where disposing of the foam layer comprises sending the foam layer to a supercritical water oxidation reactor.

Clause 9. The method of any foregoing clause further including releasing the cleaned stream into an environment.

Clause 10. A system for using foam fractionation to remove a PFAS contaminant from a water source, the system including a feed stream comprising water and one or more contaminants; a gas, where the gas is operable to induce a plurality of bubbles to form in the feed stream, and create a foam layer to form at and above the interface of the feed stream, where the foam layer comprises the one or more contaminants in the feed stream; and a plurality of columns, where each column in the plurality of columns comprises a feed inlet, wherein the feed inlet is configured to receive the feed stream, each column in the plurality of columns is operably configured to separate the one or more contaminants in the feed stream into a foam layer and a purified stream, each column in the plurality of columns comprises a gas inlet, wherein the gas inlet is configured to allow the gas to enter the column, each column in the plurality of the columns comprises a foam outlet, each column in the plurality of the columns comprises a feed outlet, wherein the feed outlet is configured to discharge the purified stream, and each column in the plurality of the columns is coupled to one or more other column in the plurality of the columns to allow a continuous passage of the feed stream through the plurality of columns.

Clause 11. The system of any foregoing clause, where the one or more contaminants comprise PFAS.

Clause 12. The system of any foregoing clause, where the foam outlet is operatively connected to a foam storage tank.

Clause 13. The system of any foregoing clause, where the foam storage tank is operatively connected to a device for destroying the one or more contaminants.

Clause 14. The system of any foregoing clause further comprising a supercritical water oxidation reactor.

Clause 15. The system of any foregoing clause further comprising a removal device for removing at least a portion of the foam layer from each column in the plurality of columns.

Clause 16. The system of any foregoing clause, where the feed inlet is configured to introduce the feed stream into each column in the plurality of columns through an upper region of each column in the plurality of columns.

Clause 17. The system of any foregoing clause, where the feed outlet is configured to introduce the discharge stream into each column in the plurality of columns through a lower region of each column in the plurality of columns.

Clause 18. A method for using foam fractionation to remove a PFAS contaminant from a water source, the method including selecting a feed stream, where the feed stream comprises the PFAS contaminant and water; providing the feed stream to a column, where the column is operatively connected to a series of fractionation columns, the series of fractionation columns perform continuous foam fractionation, and the column and each fractionation column in the series of fractionation columns operate at an operating pressure, where the operating pressure is identical between the column and each fractionation column in the series of fractionation columns; super-saturating the feed stream with air; resultant from the operating pressure of the column, generating a plurality of bubbles in the feed stream; resultant from the generating of a plurality of bubbles, creating a foam layer; collecting the foam layer; and passing the foam layer through a supercritical water oxidation reactor.

Clause 19. The method of any foregoing clause further comprising adding an effective amount of a surfactant to the feed stream.

Clause 20. The system of any foregoing clause further comprising, after collecting the foam layer, discharging a cleaned stream from a final column in the series of fractionation columns.

Clause 21. The system of any foregoing clause, where the PFAS contaminant in the feed stream has an initial PFAS concentration, the foam layer has a removed PFAS concentration, and the cleaned stream has a final PFAS concentration.

Clause 22. The system of any foregoing clause, where the initial PFAS concentration is equal to that of the removed PFAS concentration added to the final PFAS concentration, and where the removed PFAS concentration is greater than or equal to the final PFAS concentration.

Clause 23. The method of any foregoing clause further comprising releasing the cleaned stream into an environment.

Clause 24. A flexible and modular system for utilizing foam fractionation to remove a PFAS contaminant from a water source, the system including a feed stream including water and one or more contaminants; a gas, operable to induce a plurality of bubbles to form in the feed stream, and create a foam layer at and above the interface of the feed stream, where the foam layer includes the one or more contaminants in the feed stream; a plurality of foam fractionation columns, where each column in the plurality of columns includes a feed inlet, configured to receive the feed stream, each column is operably configured to separate the one or more contaminants in the feed stream into a foam layer and a purified stream, each column includes a gas inlet, configured to allow the gas to enter the column, each column includes a foam outlet, each column includes a feed outlet, configured to discharge the purified stream, each column is coupled to one or more other columns to allow a continuous passage of the feed stream through the plurality of columns, and the system is configurable in a variety of arrangements; a plurality of inlet ports, where the system allows for the flow to be routed based on the use of the plurality of inlet ports; and a plurality of modular components, where the plurality of modular components are configured to be removed from a housing to allow for increased concentration.

Clause 25. The system of any foregoing clause, where one or more foam fractionation columns in the plurality of foam fractionation columns are connected in parallel.

Clause 26. The system of any foregoing clause, where the plurality of foam fractionation columns include a number of foam fractionation systems, where the number of foam fractionation systems are physically adjustable to meet a pre-determined need.

Clause 27. The system of any foregoing clause, where the plurality of foam fractionation columns includes a number of foam fractionation systems, where a width established by the number of foam fractionation systems determines the total flow capacity.

Clause 28. The system of any foregoing clause, where the plurality of foam fractionation columns includes a number of foam fractionation systems, where the number of foam fractionation systems in series determines the total degree of water purification.

Clause 28. The system of any foregoing clause, where the plurality inlet ports are configured to affect the flow and increase concentration of the one or more contaminants in the foam layer.

Clause 30. The system of any foregoing clause, where the plurality of foam fractionation columns are oriented to route the flow through additional stages in the multistage process, where the routing allows for increased flow and increased concentration.

Clause 31. The system of any foregoing clause, where the modular components are freely movable.

Clause 32. The system of any foregoing clause, where the modular components allow for one or more foam fractionation columns in the plurality of foam fractionation columns to be taken out of a housing.

Clause 33. The system of any foregoing clause, where the modular components are operatively configured to be received by skids that fit into containers, where the skids are removable from the containers.

Clause 34. The system of any foregoing clause, where removing the foam fractionation columns and portions of the system from a housing allows for increased concentration.

Clause 35. The system of any foregoing clause, further including a containerized system with external skids.

Clause 36. The system of any foregoing clause, where the containerized system with external skids are configured to be deployed to increase either concentration or flow.

Clause 37. The system of any foregoing clause, where the containerized system provides a temporary increase in capability.

Clause 38. The system of any foregoing clause, where the containerized system progressively increases the capacity as need increases.

Clause 39. An angled foam fractionation column for removing one or more PFAS contaminants from a water source, the column comprising: a feed inlet configured to receive a feed stream comprising water, one or more PFAS contaminants, and an effective amount of a surfactant, wherein the surfactant interacts with the PFAS contaminant to form a complexing agent facilitating the removal of light PFAS; a gas inlet configured to allow the entry of a gas operable to induce a plurality of bubbles in the feed stream and create a foam layer at and above the interface of the feed stream, wherein the foam layer comprises the complexing agent and the one or more contaminants; a foam outlet for discharging the foam layer; a feed outlet configured to discharge a purified stream; and a top portion angled at an angle (a) with respect to the vertical axis of the column, wherein the angled top portion decreases the vertical distance a retained water molecule needs to travel, facilitating the drainage of water from the foam and resulting in a more concentrated foamate.

Clause 40. The angled foam fractionation column of any foregoing clause, where the angle (a) of the top portion is approximately 45 degrees to optimize the drainage of water from the foam.

Clause 41. The angled foam fractionation column of any foregoing clause, where the angling of the top portion results in minimizing the volume of water retained in the foam, thereby producing a relatively dry foam.

Clause 42. The angled foam fractionation column of any foregoing clause, where the production of a relatively dry foam increases the concentration of the target PFAS contaminants in the foamate.

Clause 43. The angled foam fractionation column of any foregoing clause, where the increased concentration of PFAS contaminants in the foamate is facilitated by the elevated solute concentrations in the liquid that originates from bubble breakage.

Clause 44. The angled foam fractionation column of any foregoing clause further including a mechanism for injecting compressed air into the liquid phase at the bottom of the column to generate foam.

Clause 45. The angled foam fractionation column of any foregoing clause, where the compressed air induces a plurality of bubbles in the feed stream, creating a foam layer at and above the interface of the feed stream.

Clause 46. The angled foam fractionation column of any foregoing clause, where the foam layer comprises a complexing agent formed by the interaction of the surfactant and the one or more PFAS contaminants, facilitating the removal of light PFAS.

Clause 47. The angled foam fractionation column of any foregoing clause, where the decreased vertical distance a retained water molecule needs to travel due to the angled top portion facilitates the drainage of water, leading to a more concentrated foamate.

Clause 48. The angled foam fractionation column of any foregoing clause, where the column is part of a system comprising a plurality of such columns, each coupled to one or more other columns allowing continuous passage of the feed stream and comprising ports for surfactant addition located throughout various columns to optimize the volume of foam produced in each stage and ensure sufficient surfactant presence.

Clause 49. A system for using foam fractionation to remove a PFAS contaminant from a water source, the system comprising a feed stream comprising water, one or more PFAS contaminants, and an effective amount of a surfactant, wherein the surfactant interacts with the PFAS contaminant to form a complexing agent facilitating the removal of light PFAS; a gas, operable to induce a plurality of bubbles in the feed stream and create a foam layer at and above the interface of the feed stream, wherein the foam layer comprises the complexing agent and the one or more contaminants; a plurality of columns, wherein each column comprises a feed inlet configured to receive the feed stream and a gas inlet configured to allow the gas to enter, each column is operably configured to separate the contaminants into a foam layer and a purified stream, each column comprises a foam outlet and a feed outlet configured to discharge the purified stream, each column is coupled to one or more other columns allowing continuous passage of the feed stream, the plurality of columns comprise a plurality of ports for surfactant addition, wherein the plurality of ports are located throughout various columns in the plurality of columns to optimize the volume of foam produced in each stage and ensure sufficient surfactant presence, and the plurality of ports for adding surfactants are installed in a configuration enabling the addition of surfactants at different columns, such as every other column.

Clause 50. The system of any foregoing clause, where the system is adaptable to incorporate different surfactant amounts and/or types at different points, enabling the addition of more columns for enhanced separation.

Clause 51. The system of any foregoing clause, where at least one column in the plurality of columns comprises an angled top portion, where the angled top portion is disposed at an angle (a) with respect to the vertical axis of the column, facilitating the drainage of water from the foam and resulting in a more concentrated foamate; the decrease in vertical distance a retained water molecule needs to travel due to the angled top portion enhances the efficiency of foam fractionation by maximizing the concentration of target molecules in the foamate; and the angle (a) is configured to minimize the volume of retained water in the foam, thereby producing a relatively dry foam and increasing solute concentrations in the foamate from the drainage of bubble breakage; and

Clause 52. The system of any foregoing clause, wherein the angle (a) is approximately 45 degrees.

Clause 53. A method for the destruction of AFFF and other wastes containing PFAS compounds, the method including: introducing a contaminated source, where the contaminated source includes PFAS contaminants, non-PFAS contaminates, and an aqueous solution; oxidizing the non-PFAS contaminates in the introduced contaminated stream, thereby leaving most of the PFAS contaminants in their original form and decomposing non-PFAS contaminants present in the contaminated stream; utilizing foam fractionation-based separation and concentration of PFAS compounds; resultant from utilizing foam fractionation-based separation, producing a first stream comprising concentrated PFAS compounds and a second stream comprising purified water; destroying the concentrated PFAS compounds in the first stream.

Clause 54. The method any foregoing clause, where the oxidation of non-PFAS contaminants in the introduced contaminated stream includes use of ultraviolet (UV) radiation, ozone, hydrogen peroxide, sodium persulfate, phosphoric acid, or a combination thereof.

Clause 55. The method any foregoing clause, where the ultraviolet (UV) radiation used in the oxidation process is in the range of 15 nm to 220 nm.

Clause 56. The method any foregoing clause, where the UV radiation is combined with use of peroxide, ozone, ammonium, sodium persulfate, or combinations thereof.

Clause 57. The method any foregoing clause further including using a recycle stream to dilute the contaminated source, thereby preventing a build-up of oxidizable contaminants.

Clause 58. The method any foregoing clause, where the introduced contaminated stream is diluted to a level suitable for measuring incoming total organic carbon (TOC).

Clause 59. The method any foregoing clause, where the foam fractionation-based separation utilizes co-surfactants to enhance PFAS concentration and suppress concentration of inorganic materials.

Clause 60. The method any foregoing clause, where the foam fractionation-based separation produces a first stream that is a highly concentrated PFAS stream or foam, and a second stream that is a disposable water stream free of PFAS compounds.

Clause 61. The method any foregoing clause, where the destruction of the concentrated PFAS compounds in the first stream is carried out by supercritical water oxidation.

Clause 62. The method any foregoing clause, where the destruction of the concentrated PFAS compounds in the first stream is carried out by high temperature, low pressure, mineralization using metal oxides with enhanced reactivity.

Clause 63. A method for removing total organic carbon (TOC) prior to supercritical water oxidation of a contaminated stream, the method including introducing a contaminated stream including PFAS contaminants and non-PFAS contaminants, where the non-PFAS contaminants include TOC; diluting the introduced stream to a level suitable for measuring the TOC; applying an applied amount of UV radiation to reduce a content of the TOC; oxidizing the non-PFAS contaminants, leaving most of the PFAS compounds in the contaminated stream.

Clause 64. The method of any foregoing clause further comprising separating and concentrating the remaining PFAS compounds using foam fractionation.

Clause 65. The method of any foregoing clause further comprising destroying the concentrated PFAS compounds using supercritical water oxidation.

Clause 66. The method of any foregoing clause, where the UV emits approximately 185 nm.

Clause 67. The method of any foregoing clause, where the UV emits in a range between approximately 15 nm and approximately 220 nm.

Clause 68. The method of any foregoing clause, where the UV is introduced in the presence of an oxidant.

Clause 69. The method of any foregoing clause, where the oxidant is peroxide.

Clause 70. The method of any foregoing clause, where the oxidant is ozone.

Clause 71. The method of any foregoing clause further comprising utilizing a recycle stream to dilute the feed, thereby preventing a build-up of oxidizable contaminants in the recycle loop.

Clause 72. A system for the destruction of PFAS compounds through mineralization with reactive oxides, the system including an acquisition unit for obtaining reactive oxides; a mixing unit operatively connected to the acquisition unit, where the mixing unit is configured to combine PFAS-contaminated waste with the reactive oxides; a high-temperature treatment unit operatively connected to the mixing unit, where the high-temperature treatment unit is configured to subject the mixture of PFAS-contaminated waste and reactive oxides to a chemical reaction; a cooling unit operatively connected to the high-temperature treatment unit, where the cooling unit is configured to cool the mixture post high-temperature treatment to create a cooled mixture; a waste collection receptacle connected to the cooling unit, where the cooled mixture is directed for disposal; and one or more particulate vapor treatment systems connected to the high-temperature treatment unit and the cooling unit, where PFAS-contaminated atmospheres from the high-temperature treatment unit and the cooling unit are captured to prevent emissions to the environment.

Clause 73. The system of any foregoing clause, where the reactive oxides comprise metal oxides.

Clause 74. The system of any foregoing clause, where the reactive oxides or hydroxides are selected from the group consisting of CaO, MgO, Ca(OH)₂, Mg(OH)₂, or a mixture thereof.

Clause 75. The system of any foregoing clause, where the acquisition unit operates at a first temperature in a range between approximately 300° C. and approximately 800° C.

Clause 76. The system of any foregoing clause, where the PFAS-contaminated waste is selected from the group consisting of concentrated foam from a foam fractionation system, AFFF, soil, water from washing soil, plastic containers contaminated with PFAS, or combinations thereof.

Clause 77. The system of any foregoing clause, where the mixing is performed using equipment selected from the group consisting of conventional mixers, rotary kilns, calciners, fluidized beds, or a combination thereof.

Clause 78. The system of any foregoing clause, where the high-temperature treatment unit operates at a second temperature between approximately 400° C. and approximately 650° C.

Clause 79. The system of any foregoing clause, where the high-temperature treatment unit comprises furnaces, belt furnaces, rotary kilns, fluidized beds, or combinations thereof.

Clause 80. The system of any foregoing clause, where the cooling unit and the high-temperature treatment unit are a single unit.

Clause 81. The system of any foregoing clause, where the cooling unit and the high-temperature treatment unit are two separate units.

Clause 82. The system of any foregoing clause, where the PFAS-contaminated waste comprises solid waste.

Clause 83. The system of any foregoing clause, where the PFAS-contaminated waste comprises PFAS-contaminated containers.

Clause 84. The system of any foregoing clause further including a shredding unit configured to reduce the PFAS-contaminated waste into smaller pieces, facilitating the mixing with reactive oxides.

Clause 85. The system of any foregoing clause, where the PFAS-contaminated containers are plastic containers used to store AFFF.

Clause 86. The system of any foregoing clause, where the shredding unit is connected to a closed storage system designed to contain the shredded pieces and minimize the hazards associated with plastic dust and PFAS emissions.

Clause 87. The system of any foregoing clause, where the shredded pieces of PFAS-contaminated waste stored in the closed storage system are transported to the mixing unit for combination with the reactive oxides.

Clause 88. The system of any foregoing clause, where the high-temperature treatment unit operates at atmospheric pressure.

Clause 89. The system of any foregoing clause, where the treatment of PFAS-contaminated waste in the high-temperature treatment unit results in the decomposition of the waste, distinct from incineration.

Clause 90. The system of any foregoing clause, where the reactive oxides used in the acquisition unit are metal oxides obtained through thermal decomposition of metal hydroxides selected from the group consisting of Ca(OH)₂, Mg(OH)₂, or a mixture thereof.

Clause 91. The system of any foregoing clause, where the metal hydroxides are decomposed at a decomposition temperature in a range between approximately 300° C. and approximately 800° C.

Clause 92. A method for treating highly contaminated soil using a PFAS mineralization system, the method including obtaining a quantity of highly contaminated soil, where the highly contaminated soil comprises PFAS compounds; mixing the obtained soil with reactants selected from the group consisting of oxides, hydroxides, or a combination thereof, placing the mixture into a high-temperature treatment unit to allow for chemical decomposition of the PFAS compounds, where the placing the mixture into a high-temperature treatment unit results in a treated mixture; cooling the treated mixture to create a cooled mixture; and disposing of the cooled mixture.

Clause 93. The method of any foregoing clause, where the high-temperature treatment unit is a batch oven, kiln, fluidized bed, or combination thereof.

Clause 94. The method of any foregoing clause, where the high-temperature treatment unit is configured to optimize the chemical decomposition of the PFAS in the soil.

Clause 95. The method of any foregoing clause, where the mixing of the highly contaminated soil with reactants is performed thoroughly to ensure uniform reaction during high-temperature treatment.

Clause 96. The method of any foregoing clause, where the disposing further comprises measures to ensure safe disposal in accordance with environmental regulations.

Clause 97. The method of any foregoing clause, where the mixture is allowed to cool to a predetermined temperature before disposal.

Clause 98. The method of any foregoing clause, where the reactants used for mixing with the highly contaminated soil are pre-determined based on the level of contamination in the soil.

Clause 99. The method of any foregoing clause, where the high-temperature treatment is configured to specifically target the decomposition of PFAS compounds present in the soil.

Clause 100. The method of any foregoing clause further including a step of monitoring the temperature during the high-temperature treatment to ensure optimal decomposition of PFAS.

Clause 101. A system for treating PFAS-contaminated soil, comprising a foam fractionation unit for separating PFAS from contaminated soil water mixture, resulting in a PFAS-enriched foam and clean water; and a mineralization unit for treating the PFAS-enriched foam to destroy PFAS using reactive oxide mineralization processes, wherein the clean water generated from the foam fractionation unit is reused for further washing of PFAS-contaminated soil.

Clause 102. The system of any foregoing clause, wherein the foam fractionation unit utilizes surfactants to enhance the separation of PFAS into the foam.

Clause 103. The system of any foregoing clause, further comprising a soil agitation mechanism to facilitate the release of PFAS into the washing water.

Clause 104. The system of any foregoing clause, wherein the mineralization unit includes a catalyst to accelerate the destruction of PFAS.

Clause 105. The system of any foregoing clause, wherein the foam fractionation unit is capable of operating under variable pressure conditions to optimize PFAS capture.

Clause 106. The system of any foregoing clause, wherein the mineralization unit operates at elevated temperatures to enhance PFAS destruction.

Clause 107. The system of any foregoing clause, further comprising a monitoring system for detecting PFAS concentration levels in the clean water and foam.

Clause 108. The system of any foregoing clause, wherein the foam fractionation and mineralization units are modular and can be scaled according to the extent of soil contamination.

Clause 109. The system of any foregoing clause, where the clean water undergoes filtration to remove any residual particulates before being reused.

Clause 110. The system of any foregoing clause, including a waste handling system for the byproducts of the PFAS destruction process.

Clause 111. The system of any foregoing clause, wherein the foam fractionation unit includes a feedback loop to adjust operational parameters based on the quality of the output water and foam.

Clause 112. The system of any foregoing clause, equipped with a control system using artificial intelligence to optimize the process parameters based on real-time data.

Clause 113. The system of any foregoing clause, including an energy recovery system to utilize heat generated during the mineralization process.

Clause 114. A method for remediating PFAS-contaminated soil, comprising the steps of: (a) washing the PFAS-contaminated soil with water to dissolve PFAS into the water; (b) pumping the PFAS-containing water into a foam fractionation unit to separate PFAS from the water, producing clean water and PFAS-enriched foam; (c) reusing the clean water to wash additional PFAS-contaminated soil; and (d) processing the PFAS-enriched foam through a mineralization unit to destroy the PFAS.

Clause 115. The method of any foregoing clause, wherein the step of washing PFAS-contaminated soil includes adding surfactants to the water to improve PFAS dissolution.

Clause 116. The method of any foregoing clause, further comprising the step of agitating the PFAS-contaminated soil to enhance PFAS release into the water.

Clause 117. The method of any foregoing clause, wherein the mineralization process is catalyzed by adding specific catalysts to the mineralization unit.

Clause 118. The method of any foregoing clause, wherein the clean water is treated with UV light before being reused for soil washing.

Clause 119. The method of any foregoing clause, wherein the PFAS-enriched foam is subjected to multiple cycles of mineralization to ensure complete PFAS destruction.

Clause 120. The method of any foregoing clause, including the use of reactive oxides selected from the group consisting of magnesium oxide, zinc oxide, and titanium dioxide in the mineralization process.

Clause 121. The method of any foregoing clause, where the washing water's pH is adjusted to optimize PFAS dissolution.

Clause 122. The method of any foregoing clause, wherein the mineralization unit uses a combination of reactive oxides to target different PFAS compounds.

Clause 123. A method for the destruction of perfluoroalkyl or polyfluoroalkyl substances (PFAS) in flue gases of high-temperature waste treatment systems, comprising: injecting one or more basic oxides and/or hydroxides into the flue gas at one or more stages of the incineration process to facilitate decomposition of PFAS compounds.

Clause 124. The method of any foregoing clause, wherein the basic oxides and/or hydroxides are selected from the group consisting of CaO, Ca(OH)₂, MgO, and Mg(OH)₂.

Clause 125. The method of any foregoing clause, wherein the injection takes place into the air intake of the incinerator.

Clause 126. The method of any foregoing clause, wherein the injection takes place directly into the flame within the incinerator.

Clause 127. The method of any foregoing clause, wherein the injection takes place into the hot exhaust post-incineration.

Clause 128. The method of any foregoing clause, further including the step of adjusting the quantity of basic oxides and/or hydroxides injected based on the concentration of PFAS in the flue gas.

Clause 129. The method of any foregoing clause, wherein the basic oxides and/or hydroxides are injected as dry powders.

Clause 130. The method of any foregoing clause, further including a preliminary step of analyzing the flue gas composition to identify predominant PFAS compounds.

Clause 131. The method of any foregoing clause, further including a step of post-treatment analysis to assess the effectiveness of PFAS decomposition.

Clause 132. The method of any foregoing clause, wherein the injection is performed continuously during incineration operations.

Clause 133. A PFAS destruction system for high temperature waste treatment systems, comprising: an injection means for introducing basic oxides and/or hydroxides into the flue gas at one or more points in the incineration process; and a control unit configured to regulate the amount and timing of the injection based on flue gas characteristics.

Clause 134. The system of any foregoing clause, further comprising a separator configured to remove powder from the treated flue gas before release into the environment, where the separator is a cyclone, an electrostatic precipitator, or a bag filter.

Clause 135. The system of any foregoing clause, where the separator is equipped with a cleaning mechanism to prevent clogging by the injected materials.

Clause 136. The system of any foregoing clause, further comprising a monitoring unit for real-time detection of PFAS compounds in the flue gas.

Clause 137. The system of any foregoing clause, wherein the injection means includes a plurality of nozzles positioned at strategic locations within the incineration system.

Clause 138. The system of any foregoing clause, further comprising feedback control loops that adjust the injection based on measured flue gas composition.

Clause 139. The system of any foregoing clause, further comprising a data storage unit for recording injection parameters and flue gas composition for analysis and optimization.

Clause 140. The system of any foregoing clause, where the separator is equipped with a cleaning mechanism to prevent clogging by the injected materials.

Clause 141. The system of any foregoing clause, where the control unit is programmed with algorithms to optimize injection timing and quantity based on historical data.

Clause 142. A dry scrubbing method for reducing PFAS compounds in the flue gas of incineration systems, comprising: identifying stages in the incineration process where PFAS concentrations in flue gas are elevated; and injecting a predetermined quantity of basic oxides and/or hydroxides into the flue gas at the identified stages to decompose PFAS compounds.

Clause 143. The method of any foregoing clause, where the injection of basic oxides and/or hydroxides additionally facilitates the capture of sulfur oxides and other acid gases.

Clause 144. The method of any foregoing clause, further including the step of modifying injection points based on flue gas flow dynamics to optimize PFAS decomposition.

Clause 145. The method of any foregoing clause, wherein the basic oxides and/or hydroxides are pre-treated or activated to enhance their reactivity with PFAS compounds.

Clause 146. A system for mineralizing per- and polyfluoroalkyl substances (PFAS) present in solid waste containers, comprising: a shredder for reducing PFAS-contaminated containers into small pieces; a mixing unit for combining the shredded pieces with reactive oxides; a treatment chamber for exposing the mixture to high temperature conditions sufficient to decompose PFAS compounds.

### REFERENCES

Wang, F., L. Xingwen, L. Xiao-yan, and S. Kaimin, Effectiveness and mechanisms of defluorination of per fluorinated alkyl substances by calcium compounds during waste thermal treatment. Environmental Science and Technology, 2015. 49: p. 4672-5680.
Riedel, T. P., et al., Low temperature thermal treatment of gas-phase fluorotelomer alcohols by calcium oxide. Chemosphere, 2021. 272: p. 129859.
Koper, O. B., Properties of High Surface Area Calcium Oxide and its Reactivity Towards Chlorocarbons, 1996, Kansas State University.
Koper, O. B., Y. X. Li, and K. J. Klabunde, Destructive Adsorption of Chlorinated Hydrocarbons on Ultrafine (Nanoscale) Particles of Calcium Oxide. Chemistry of Materials, 1993. 5: p. 500-505.
Koper, O. B., Properties of High Surface Area Calcium Oxide and its Reactivity Towards Chlorocarbons, Ph.D. Thesis, 1996, Kansas State University.
Koper, O. B. and K. J. Klabunde, Destructive Adsorption of Chlorinated Hydrocarbons on Ultrafine (Nanoscale) Particles of Calcium Oxide. 3. Chloroform, Trichloroethene, and Tetrachloroethene. Chemistry of Materials, 1997. 9: p. 2481-2485.
Koper, O. B., S. Rajagopalan, S. Winecki, and K. J. Klabunde, Metal Oxides for Chlorocarbon and Organophosphonate Remediation, in Environmental Applications of Nanomaterials, G. E. Fryxell and G. Cao, Editors. 2012, Imperial College Press. p. 3-24.
Winecki, S., Selected Environmental Applications of Nanocrystalline Metal Oxides, in Nanoscale Materials in Chemistry: Environmental Applications, L. E. Erickson, R. T. Koodali, and R. M. Richards, Editors. 2010, ACS Symposium Series. p. 77-95.
Klabunde, J. K., L. E. Erickson, O. B. Koper, and R. M. Richards, Review of Nanoscale Materials in Chemistry: Environmental Applications, in Nanoscale Materials in Chemistry: Environmental Applications, L. E. Erickson, R. T. Koodali, and R. M. Richards, Editors. 2010, ACS Symposium Series. p. 1-13.

What is claimed is:

1. A system for the destruction of PFAS compounds through mineralization with reactive oxides, the system comprising:
(a) an acquisition unit for obtaining reactive oxides;
(b) a mixing unit operatively connected to the acquisition unit, wherein the mixing unit is configured to combine PFAS-contaminated waste with the reactive oxides;
(c) a high-temperature treatment unit operatively connected to the mixing unit, wherein the high-temperature treatment unit is configured to subject the mixture of PFAS-contaminated waste and reactive oxides to a chemical reaction;
(d) a cooling unit operatively connected to the high-temperature treatment unit, wherein the cooling unit is configured to cool the mixture post high-temperature treatment to create a cooled mixture;
(e) a waste collection receptacle connected to the cooling unit, wherein the cooled mixture is directed for disposal; and
(f) one or more particulate vapor treatment systems connected to the high-temperature treatment unit and the cooling unit, wherein PFAS-contaminated atmospheres from the high-temperature treatment unit and the cooling unit are captured to prevent emissions to the environment.

2. The system of claim 1, wherein the reactive oxides comprise metal oxides.

3. The system of claim 1, wherein the reactive oxides or hydroxides are selected from the group consisting of CaO, MgO, Ca(OH)₂, Mg(OH)₂, or a mixture thereof.

4. The system of claim 1, wherein the acquisition unit operates at a first temperature in a range between approximately 300° C. and approximately 800° C.

5. The system of claim 1, wherein the PFAS-contaminated waste is selected from the group consisting of concentrated foam from a foam fractionation system, AFFF, soil, water from washing soil, plastic containers contaminated with PFAS, or combinations thereof.

6. The system of claim 1, wherein the mixing is performed using equipment selected from the group consisting of conventional mixers, rotary kilns, calciners, fluidized beds, or a combination thereof.

7. The system of claim 1, wherein the high-temperature treatment unit operates at a second temperature between approximately 400° C. and approximately 650° C.

8. The system of claim 1, wherein the high-temperature treatment unit comprises furnaces, belt furnaces, rotary kilns, or combinations thereof.

9. The system of claim 1, wherein the cooling unit and the high-temperature treatment unit are a single unit.

10. The system of claim 1, wherein the cooling unit and the high-temperature treatment unit are two or more separate units.

11. The system of claim 1, wherein the PFAS-contaminated waste comprises solid waste.

12. The system of claim 1, wherein the PFAS-contaminated waste comprises PFAS-contaminated containers.

13. The system of claim 11 further comprising a shredding unit configured to reduce the PFAS-contaminated waste into smaller pieces, facilitating the mixing with reactive oxides.

14. The system of claim 13, wherein the PFAS-contaminated containers are plastic containers used to store AFFF.

15. The system of claim 13, wherein the shredding unit is connected to a closed storage system designed to contain the shredded pieces and minimize the hazards associated with plastic dust and PFAS emissions.

16. The system of claim 15, wherein the shredded pieces of PFAS-contaminated waste stored in the closed storage system are transported to the mixing unit for combination with the reactive oxides.

17. The system of claim 1, wherein the high-temperature treatment unit operates at atmospheric pressure.

18. The system of claim 1, wherein the treatment of PFAS-contaminated waste in the high-temperature treatment unit results in the decomposition of the waste, distinct from incineration.

19. The system of claim 1, wherein the reactive oxides used in the acquisition unit are metal oxides obtained through thermal decomposition of metal hydroxides selected from the group consisting of CaO, MgO, Ca(OH)₂, Mg(OH)₂, or a mixture thereof.

20. The system of claim 19, wherein the metal hydroxides are decomposed at a decomposition temperature in a range between approximately 300° C. and approximately 800° C.

21. A method for treating highly contaminated soil using a PFAS mineralization system, the method comprising:
(a) obtaining a quantity of highly contaminated soil, wherein the highly contaminated soil comprises PFAS compounds;
(b) mixing the obtained soil with reactants selected from the group consisting of oxides, hydroxides, or a combination thereof;
(c) placing the mixture into a high-temperature treatment unit to allow for chemical decomposition of the PFAS compounds, wherein the placing the mixture into a high-temperature treatment unit results in a treated mixture;
(d) cooling the treated mixture to create a cooled mixture; and
(e) disposing of the cooled mixture.

22. The method of claim 21, wherein the high-temperature treatment unit is a batch oven, kiln, fluidized bed, or combination thereof.

23. The method of claim 22, wherein the high-temperature treatment unit is configured to optimize the chemical decomposition of the PFAS in the soil.

24. The method of claim 21, wherein the mixing of the highly contaminated soil with reactants is performed thoroughly to ensure uniform reaction during high-temperature treatment.

25. The method of claim 21, wherein the disposing further comprises measures to ensure safe disposal in accordance with environmental regulations.

26. The method of claim 21, wherein the mixture is allowed to cool to a predetermined temperature before disposal.

27. The method of claim 21, wherein the reactants used for mixing with the highly contaminated soil are pre-determined based on the level of contamination in the soil.

28. The method of claim 21, wherein the high-temperature treatment is configured to specifically target the decomposition of PFAS compounds present in the soil.

29. The method of claim 21 further comprising a step of monitoring the temperature during the high-temperature treatment to ensure optimal decomposition of PFAS.
